(19) United States
(12) Patent Application Publication
(10) Pub. No.: US 2024/0321067 A1
(43) Pub. Date: Sep. 26, 2024

(54) SENSOR-INTEGRATED ACTUATOR, AND HAPTIC FEEDBACK SYSTEM USING SAME

(71) Applicants: POSTECH RESEARCH AND BUSINESS DEVELOPMENT FOUNDATION, Pohang-si (KR); Seoul National University R&DB Foundation, Seoul (KR)

(72) Inventors: Moon Jeong Park, Pohang-si (KR); Yong-Lae Park, Seoul (KR); Myungsun Park, Seoul (KR); HYEON SEONG HAM, Seoul (KR)

(21) Appl. No.: 18/612,259

(22) Filed: Mar. 21, 2024

(30) Foreign Application Priority Data
Mar. 22, 2023 (KR) 10-2023-0037572
Mar. 20, 2024 (KR) 10-2024-0038697

(51) Int. Cl. G08B 6/00; G01L 1/22

(52) U.S. Cl. CPC G08B 6/00; G01L 1/2287

(57) ABSTRACT

Haptic interaction system remotely operated by human hand through real-time haptic feedback, and a sensor-integrated iEAP actuator included in the system are provided, in which when a gripper including the sensor-integrated iEAP actuator that operates in conjunction with the user's finger movements comes into contact with an object, changes in signal of the sensor included in the sensor-integrated iEAP actuator are transmitted to the user as haptic feedback in real time, thereby enabling stable gripping without a visual sensor.

### CROSS REFERENCE TO RELATED APPLICATIONS

This application claims priority to and the benefit of Korean Patent Application No. 10-2023-0037572 filed in the Korean Intellectual Property Office on Mar. 22, 2023, and Korean Patent Application No. 10-2024-0038697 filed in the Korean Intellectual Property Office on Mar. 20, 2024, the entire contents of which are incorporated herein by reference.

### BACKGROUND

### 1. Field

Sensor-integrated actuators, and haptic interaction system including same are disclosed.

### 2. Description of the Related Art

While grasping, transporting, and deforming objects are easy tasks for humans, making robots to perform these tasks requires considerable effort. In particular, manipulating delicate objects on a small scale using robots requires well-designed robotic manipulators and sophisticated, integrated perception and control. Soft robots are preferred over their rigid counterparts for grasping and manipulation of different types of objects. To envisage such soft robots, development of a compact, precise, and controllable soft actuator must be preceded.

### SUMMARY

An embodiment provides a sensor-integrated actuator that may be operated at a low voltage, lightweight, portable, and has a self-sensing function to track its operating status in real time.

Another embodiment provides a haptic interaction system including a sensor-integrated actuator, which may allow a real-time control according to the user's movements.

A haptic interaction system according to one embodiment includes:
a sensing glove configured to be worn on a user's hand to detect movement of the user's hand;
a soft gripper including a sensor-integrated actuator and configured to be operated according to the movement of the user's hand;
a haptic device including an ionic electroactive polymer (iEAP) actuator and providing haptic feedback of the soft gripper to the user's hand; and
a haptic interface that generates tracking control that synchronizes movement of the user's hand with the movement of the soft gripper and generates a haptic feedback signal from a physical contact of the soft gripper with an object.

The sensor-integrated actuator may include an iEAP actuator, and a strain sensor coupled to the iEAP actuator.

At least one of the iEAP actuator and the strain sensor is encapsulated with an elastomer.

The strain sensor may include an eutectic gallium-indium (EGaIn) alloy.

The sensor-integrated actuator may include a strain sensor printed on an elastomer film, and an iEAP actuator laminated on the strain sensor, wherein the iEAP actuator is sealed with an elastomer.

The iEAP actuator may include a pair of flexible electrodes that face each other, and a polymer electrolyte membrane interposed between the pair of flexible electrodes, wherein the polymer electrolyte membrane may include a polymer that comprises a structural unit represented by Chemical Formula 1, and an ionic liquid:

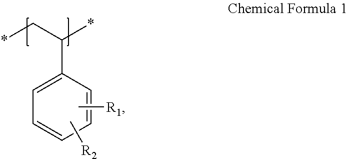

wherein in Chemical Formula 1,
R₁ and R₂ may, each independently, be —OH, —COOH, —SO₃H, —PO₃H₂, —NH₂, imidazolyl group, —SO₂N(X₁)SO₂CF₃, or —CN, wherein X₁ may be hydrogen, or a substituted or unsubstituted C₁ to C₃₀ alkyl group, and
wherein R₁ and R₂ may be located adjacent to each other.

The Chemical Formula 1 may be represented by Chemical Formula 1-1 or Chemical Formula 1-2:

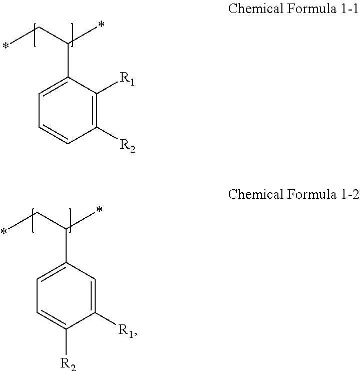

wherein in Chemical Formula 1-1 and Chemical Formula 1-2,
R₁ and R₂ may, each independently, be the same as defined in Chemical Formula 1.

The Chemical Formula 1 may be represented by Chemical Formula 2:

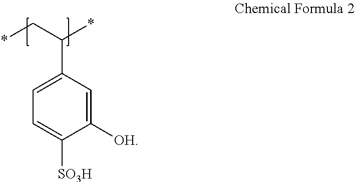

The ionic liquid may include a cationic liquid, an anionic liquid, a neutral liquid, or a combination thereof.

The cationic liquid may include imidazolium, pyrrolidinium, piperidinium, alkylmethylimidazolium, or a combination thereof;
the anionic liquid may include trifluoroacetate([tfa]⁻), trifluoromethanesulfonate([CF₃SO₃]⁻), bis(fluorosulfonyl)imide([N(SO₂F)₂]⁻), bis(trifluoromethanesulfonyl)imide([N(SO₂CF₃)₂]⁻), Dicyanamide([N(CN)₂]⁻), tetracyanoborate([B(CN)₄]⁻, dihydrogenphosphate([H₂PO₄]⁻), hydrogen sulfate([HSO₄]⁻), or a combination thereof; and
the neutral liquid may include 1-ethyl-3-methylimidazolium-bis(trifluoromethylsulfonyl)imide (EMITFSI), 1-methyl-3-propylimidazolium iodide (PMII), 1-ethyl-3-methylimidazolium tetrafluoroborate (EMIBF4), 1-ethyl-3-methylimidazolium trifluoromethanesulfonate (EMITf), 1-ethyl-3-methylimidazolium hydrogensulfate (EMIHSO4), N-methyl-N-butylpyrrolidinium-bis(trifluoromethanesulfonyl) imide (PYRTFSI), or a combination thereof.

The ionic liquid may include a mixture of the cationic liquid and the anionic liquid at a molar ratio of 1:10 to 10:1.

At least one of the pair of flexible electrodes may include a single-walled carbon nanotube (SWCNT) electrode, a multi-walled carbon nanotube (MWCNT) electrode, a PEPOT:PSS (poly(3,4-ethylenedioxythiophene):polystyrene sulfonate) conductive polymer electrode, gold (Au) electrode, a platinum (Pt) electrode, or a combination thereof.

The sensing glove may include a strain sensor that detects movement of joint of a user's finger.

The strain sensor included in the sensing glove may include an eutectic gallium-indium (EGaIn) alloy.

The haptic device may be mounted on a user's fingertip.

A sensor-integrated actuator according to another embodiment may include a strain sensor; an elastomer film on the strain sensor; and an ionic electroactive polymer (iEAP) actuator on the elastomer film, wherein the iEAP actuator may include a pair of flexible electrodes that face each other, and a polymer electrolyte membrane interposed therebetween, and wherein the polymer electrolyte membrane may include a polymer that comprises a structural unite represented by Chemical Formula 1, and an ionic liquid:

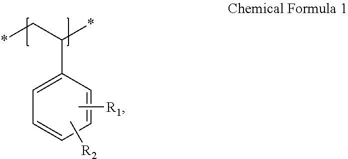

wherein in Chemical Formula 1,
R₁ and R₂ may, each independently, be —OH, —COOH, —SO₃H, —PO₃H₂, —NH₂, imidazolyl group, —SO₂N(X₁)SO₂CF₃, or —CN, wherein X₁ may be hydrogen, or a substituted or unsubstituted C₁ to C₃₀ alkyl group, and
wherein R₁ and R₂ may be located adjacent to each other.

The Chemical Formula 1 may be represented by Chemical Formula 1-1 or Chemical Formula 1-2:

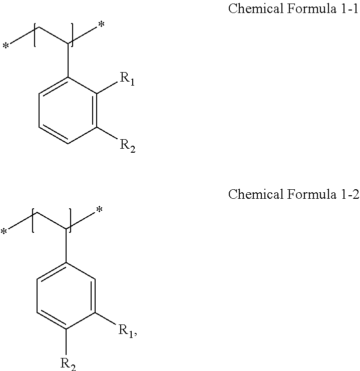

in Chemical Formula 1-1 and Chemical Formula 1-2,
R₁ and R₂ may, each independently, be the same as defined in Chemical Formula 1.

The strain sensor may include an eutectic gallium-indium (EGaIn) alloy.

The Chemical Formula 1 may be represented by Chemical Formula 2, and the ionic liquid may include a mixture of a cationic liquid and an anionic liquid at a molar ratio of 1:10 to 10:1:

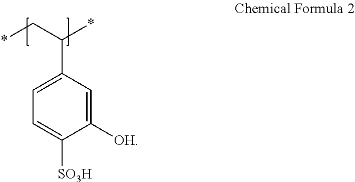

The ionic liquid may include 1-ethyl-3-methylimidazolium (EMIm⁺), bis(trifluoromethylsulfonyl)imide (TFSI⁻), or a combination thereof.

A sensor-integrated actuator according to an embodiment may include an ionic electroactive polymer actuator that comprises a superionic polymer electrolyte membrane, and a soft conductive electrode, and thus, be lightweight, but can exhibit very large strain and force at a low voltage and high frequency, and additionally, may have a self-sensing function by combining a conductive liquid metal-based strain sensor. Further, a haptic interaction system including the sensor-integrated actuator may operate by the sensor-integrated actuator detecting signals according to the user's hand movement, and may be able to provide accurate information about interaction through haptic feedback, even without visual information, by including a controller that tracks the operation trajectory and a haptic feed device that feedbacks the operation status to the user. The sensor-integrated actuator and a haptic interaction system according to an embodiment may advantageously be used in the field of soft robotics.

### BRIEF DESCRIPTION OF THE DRAWINGS

FIG. 1 is a schematic view showing the configuration of a haptic interaction system according to an embodiment.

FIG. 2 is an exploded view showing the configuration of a sensor-integrated actuator according to an embodiment.

FIG. 3 is a schematic view showing the configuration of an iEAP actuator according to an embodiment.

FIG. 4 is a chemical formula that shows ionic interaction and hydrogen bonding among functional groups of the polymer (polystyrene-3-hydroxy-4-sulfoacid) and ionic moieties in the ionic liquid that consist a polymer electrolyte membrane contained in the iEAP actuator according to an embodiment.

FIG. 5 shows a graph of X-ray scattering results of the polymer (polystyrene-3-hydroxy-4-sulfoacid: PS-3H4S)(neat PS-3H4S), and of the polymer (PS-3H4S) as well as ionic liquid ([EMIm⁺][TFSI⁻]) contained in the polymer electrolyte membrane included in an iEAP actuator according to one embodiment.

FIG. 6 schematically shows the structure of the polymer electrolyte membrane included in the iEAP actuator according to one embodiment, which is estimated from the X-ray scattering graph of FIG. 5.

FIG. 7 is a reaction scheme showing the synthesis process of the polymer (polystyrene-3-hydroxy-4-sulfoacid) included in the polymer electrolyte membrane of the iEAP actuator according to one embodiment.

FIG. 8 is a scanning electron microscopy (SEM) image showing a cross section of an iEAP actuator according to one embodiment.

FIG. 9A shows graphs of the specific capacitance of an iEAP actuator according to one embodiment that includes the polymer of PS-3H4S.

FIG. 9B shows graphs of the specific capacitance of an iEAP actuator manufactured using PVdF-HFP polymer instead of PS-3H4S polymer.

FIG. 10 is a scanning electron microscopy (SEM) image of the cross section of a sensor-integrated actuator according to one embodiment.

FIG. 11 is an image that shows that a sensor-integrated actuator is mounted on a customized electric circuit and a colored marker is attached to the end of the sensor-integrated actuator to measure the bending response and sensitivity of the sensor-integrated actuator according to one embodiment.

FIG. 12A shows time-dependent bending angles (bending response) and sensor signals (ΔR/R₀) (i.e., sensitivity) of the sensor-integrated actuator measured by using the device shown in FIG. 11, while changing the driving voltage from 0.5 V to 1.5 V, at frequency of 0.05 Hz.

FIG. 12B shows time-dependent bending angles (bending response) and sensor signals (ΔR/R₀) (i.e., sensitivity) of the sensor-integrated actuator measured by using the device shown in FIG. 11, while changing the driving voltage from 0.5 V to 1.5 V, at frequency of 0.1 Hz.

FIG. 12C shows time-dependent bending angles (bending response) and sensor signals (ΔR/R₀) (i.e., sensitivity) of the sensor-integrated actuator measured by using the device shown in FIG. 11, while changing the driving voltage from 0.5 V to 1.5 V, at frequency of 0.5 Hz.

FIG. 12D shows time-dependent bending angles (bending response) and sensor signals (ΔR/R₀) (i.e., sensitivity) of the sensor-integrated actuator measured by using the device shown in FIG. 11, while changing the driving voltage from 0.5 V to 1.5 V, at frequency of 1 Hz.

FIG. 13 shows graphs that compare the forces output over time of an iEAP actuator sealed with an elastomer and an unsealed iEAP actuator.

FIG. 14 shows front view (a) and perspective view (b) of the upper and lower parts of the haptic device produced by a 3d printer (Mark Two, Markforged).

FIG. 15 shows a cross-sectional structure of a sensor-integrated iEAP actuator according to an embodiment, and schematic relationships among the input voltage (Vᵢₙ) applied to the actuator, the strain rate (ε) of the actuator when the actuator bends left and right, the bending angle (θ), and the sensor signal (ΔR/R₀).

FIG. 16 schematically shows the strain rates of the sensor-integrated iEAP actuator calculated by the input voltage through a finite element analysis (FEA) simulation process, when the thickness (d) of the internal elastomer layer of the sensor-integrated iEAP actuator according to one embodiment is set to 0.8 mm.

FIG. 17 is a graph showing that the changes in the bending angle (θ) and the sensor signal (ΔR/R₀) of the iEAP actuator in accordance with changing thickness (d) of the internal elastomer layer of the sensor-integrated iEAP actuator according to one embodiment.

FIG. 18 is graphs that show the changes in bending angle (θ) and sensor signal (ΔR/R₀) of the sensor-integrated iEAP actuator when applying sinusoidal voltages of 0.5 V, 1 V, and 1.5 V, at a frequency of 0.2 Hz.

FIG. 19 is a graph showing linear relationship of the sensor signal (ΔR/R₀) to the bending angle (θ) of the sensor-integrated iEAP actuator according to one embodiment under a frequency of 0.2 Hz and sinusoidal voltages of 0.5 V, 1 V, and 1.5 V.

FIG. 20 is a graph showing the relationship between peak-to-peak angle and frequency of the sensor-integrated iEAP actuator according to one implementation when sinusoidal voltages of 0.5 V, 1 V, and 1.5 V are respectively applied.

FIG. 21 is a graph showing current versus cycle number of a sensor-integrated iEAP actuator according to an embodiment obtained at ±0.5V and 1 Hz.

FIG. 22A is graph showing the relationship between the sampled bending angles and the predicted bending angles, in which the sampled values are obtained from a linearly fitted dynamic model.

FIG. 22B is graph showing the relationship between the sampled sensor signals and predicted sensor signals, in which the sampled values are obtained from a linearly fitted dynamic model.

FIG. 23 is graphs that show a sensor-integrated iEAP actuator according to an embodiment successfully tracks trajectories of various predetermined shapes (sine, triangle, square, and random) at frequencies of 0.1 Hz, 0.2 Hz, and 0.5 Hz, in terms of its bending angle, sensor signal, and input voltage.

FIG. 24 is graphs showing that the sensor-integrated actuator of the soft gripper according to an embodiment follows the slow motion, stepwise motion, and fast motion well in accordance with the movement of the finger of a user wearing a sensing glove equipped with a sensor attached.

FIG. 25 is graphs showing signals for input voltage, bending angle, and contact probability when the sensor-integrated actuator of a soft gripper according to an embodiment is in free movement, in contact with an object, and in contact with an object under a higher input voltage.

FIG. 26 shows images of process in which the sensor-integrated actuators of the soft gripper operate in accordance with the movement of the fingers of a user wearing a sensing glove using a haptic interaction system according to an embodiment, in particular, the sensor-integrated actuators catch an object (ball), transport it to the goal location, and scores a goal.

FIG. 27 shows graphs of signals from a sensor attached to the sensing glove, a bending angle of a sensor-integrated actuator attached to a soft gripper, and a haptic feedback signal generated from the sensor-integrated actuator signal, until a user wearing a sensing glove completes a task using a haptic interaction system according to an embodiment.

FIG. 28 shows an image (left photo) of a haptic device constituting a haptic interaction system according to an embodiment mounted on a user's fingernail, and a graph (right) showing the magnitude of force over time when an iEAP actuator attached to the haptic device receives a contact feedback signal and sends a haptic feedback signal to the user's fingertip.

### DETAILED DESCRIPTION

Hereinafter, example embodiments will be described in detail so that a person skilled in the art would understand the same. However, a structure that is actually applied may be implemented in various different forms and is not limited to the example embodiments described herein.

The terminology used herein is used to describe embodiments only, and is not intended to limit the present disclosure. The singular expression includes the plural expression unless the context clearly dictates otherwise.

Herein, it should be understood that terms such as “comprises,” “includes,” or “have” are intended to designate the presence of an embodied feature, number, step, element, or a combination thereof, but does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element, a layer, film, region, or substrate is referred to as being “on” or “above” another element, it may be directly on the other element or intervening elements may also be present. In contrast, when an element is referred to as being “directly on” another element, there are no intervening elements present.

Hereinafter, the term “on” or “above” may include not only those immediately above, below, left, and right in contact, but also those above, below, left, and right in a non-contact manner. In addition, unless explicitly described to the contrary, the word “comprise,” and variations such as “comprises” or “comprising,” will be understood to imply the inclusion of stated elements but not the exclusion of any other elements.

In addition, “layer” herein includes not only a shape formed on the whole surface when viewed from a plan view, but also a shape formed on a partial surface.

The use of the term “the” and similar referential terms may refer to both the singular and the plural. Unless the order of the steps constituting the method is clearly stated or stated to the contrary, these steps may be performed in any appropriate order and are not necessarily limited to the order described.

In addition, terms such as “unit” and “module” used in the specification refer to a unit that processes at least one function or operation, which may be implemented as hardware or software, or as a combination of hardware and software.

The connections or connection members of lines between components shown in the drawings exemplify functional connections and/or physical or circuit connections, and in an actual device, they may be represented by a variety of alternative or additional functional, physical, or circuit connections.

As used herein, “at least one of A, B, or C,” “one of A, B, C, or any combination thereof” and “one of A, B, C, and any combination thereof” refer to each constituent element, and any combination thereof (e.g., A; B; C; A and B; A and C; B and C; or A, B, and C).

Herein, “a combination thereof” means a mixture of components, a stack, a composite, an alloy, a blend, and the like.

Hereinafter, unless otherwise defined, “substantially” or “approximately” or “about” means not only the stated value, but also the mean within an acceptable range of deviations, considering the errors associated with the corresponding measurement and the measurement of the measured value. For example, “substantially” or “approximately” can mean within ±10%, ±5%, ±3%, or ±1% or within standard deviation of the stated value.

In order to clearly explain the present invention in the drawings, parts not related to the description are omitted, and identical or similar components are given the same reference numerals throughout the specification. Additionally, in the accompanying drawings, some components are exaggerated, omitted, or schematically shown, and the size of each component does not entirely reflect the actual size.

The attached drawings are only for easy understanding of the embodiments disclosed in the present specification, and the technical idea disclosed in the present specification is not limited by the attached drawings, and all changes and equivalents included in the spirit and technical scope of the present invention are not limited to the attached drawings. It should be understood that all changes, equivalents, and substitutes included in the spirit and technical scope of the present invention are included.

Terms containing ordinal numbers, such as first, second, etc., may be used to describe various components, but the components are not limited by the terms. The above terms are used only for the purpose of distinguishing one component from another.

In addition, throughout the specification, when referring to “on a plane,” this means when the target portion is viewed from above, and when referring to “in cross-section,” this means when a cross section of the target portion is cut vertically and viewed from the side.

There has been considerable research on soft robotics in the past few decades, with remarkable advancements in producing artificial muscles, biomimetic devices, and wearable electronics. Soft actuators are key components of soft robotics. They undergo mechanical deformation in response to external stimuli such as electricity, light, heat, pressure, and humidity. Among the various types of soft actuators, electroactive polymer (EAP)-based actuators have unique advantages such as compactness and low weight. In particular, ionic EAP (iEAP) actuators have recently gained attention for securing wearable characteristics in human-friendly soft robots running on small batteries.

Studies on advancing iEAP actuators have mainly focused on the exploration of innovative EAP materials and diversification of actuator structures aimed at developing compact systems with low-power consumption. However, low-voltage iEAP actuators have not yet been used in practical robotic applications. To envisage such soft robots, three important requirements must be met: first, an iEAP actuator encapsulation technology must be established such that the actuation properties are not significantly deteriorated; second, a self-sensing iEAP actuator should be developed to track the real-time state of actuation, and, third, all the constituents should be soft, flexible, compact, and thermodynamically compatible for stable actuation during long-term operation. Elastomers have been used for the encapsulation technology in most wearable electronics; however, introducing an elastomer material into an iEAP actuator without significantly degrading the actuation properties is challenging because of the nonuniformity in its mechanical properties.

Research has been conducted on developing EAP actuators with self-sensing characteristics based on the interplay between the bending strain and electrical charge across the two electrodes (T. F. Otero, Electrochim. Acta 2021, 368, 137576). However, the driving voltage and measured charge are coupled, resulting in inaccurate real-time estimation. The integration of an additional sensor into the iEAP actuator can be an alternative, but thus far it is still in its infancy (B. Rivkin, C. Becker, F. Akbar, R. Ravishankar, D. D. Karnaushenko, R. Naumann, A. Mirhajivarzaneh, M. Medina-Sanchez, D. Karnaushenko, O. G. Schmidt, Adv. Intell. Syst. 2021, 3, 2000238). Vision sensors (e.g., optical cameras) have been introduced into the iEAP system (R. Mutlu, G. Alici, W. Li, IEEE Trans. Syst. Man Cybern.: Syst. 2016, 47, 2562). However, the use of external devices limited their applicability to wide range of systems, such as wearable devices and mobile systems in a small scale. Hence, the self-sensing capability, analogous to proprioception in biological muscles, of the actuator is highly desirable while maintaining a compact form factor and portability. It is also important for the sensor to accurately estimate the state of the actuator while in contact with an object.

In addition to real-time sensing capability, a high-level control of sensor-integrated iEAP actuators by users remains a key scientific challenge in the development of intelligent soft robots. This requires closing the sensing-signal processing-actuation loop. The concept of “human-in-the-loop (M. Raessa, J. C. Y. Chen, W. W. Wan, K. Harada, IEEE Trans. Autom. Sci. Eng. 2020, 17, 1800)” has wisely been used in recent robotics technologies for this purpose, including cell manipulation, grasping in cluttered environments, and robotic surgeries, accompanied by an interactive system that provides tactile feedback to users motion and contact state of robots (E. Gerena, F. Legendre, A. Molawade, Y. Vitry, S. Regnier, S. Haliyo, Micromachines 2019, 10, 677). Although various haptic feedback devices composed of rigid and bulky units have been combined with pneumatic actuators, these are cumbersome and not truly wearable (J. Yin, R. Hinchet, H. Shea, C. Majidi, Adv. Funct. Mater. 2021, 31, 2007428). Haptic devices using EAP actuators have also been investigated, but their scope has been limited to dielectric elastomer actuators (DEAs: Dielectric Elastomer Actuator). Despite the inherent advantages of DEAs, including large strain, high generated force, and fast response, their driving voltage ranges from several hundred volts to kilovolts, requiring additional shielding and voltage converters when used in wearable devices, which impede the compactness of the systems and reduce overall energy efficiency. A haptic feedback system that can demonstrate real-time control of soft robots using low-voltage iEAP actuators is desired.

An embodiment of the present application provides a haptic interactive system teleoperated by a human hand with real-time haptic feedback based on sensor-integrated iEAP actuators. An advanced iEAP actuator included in the haptic interactive system may include a combination of a superionic polymer electrolyte membrane and a pair of soft conducting electrodes, and thus, for example, may demonstrate a bending angle of greater than or equal to about 20° and a force of greater than or equal to about 1 mN at 2 Volts (V) and 10 Hertz (Hz). The sensor-integrated iEAP actuator has rationally been designed by introducing a conductive liquid-metal-based strain sensor into the iEAP actuator based on the actuation-sensitivity relationship. By identifying the dynamic model of the system, a controller has been designed for the actuators to accurately track the trajectories during a task, and a decision algorithm has been implemented to determine the contact state of the actuator. Furthermore, a wearable fingertip iEAP haptic device has been combined with a dynamic system model to transmit the sensor signal as cutaneous haptic feedback, thus enabling robust grasping by providing accurate information on the interaction.

Hereinafter, referring to the drawings, the haptic interactive system, and each component that consists thereof are described in detail.

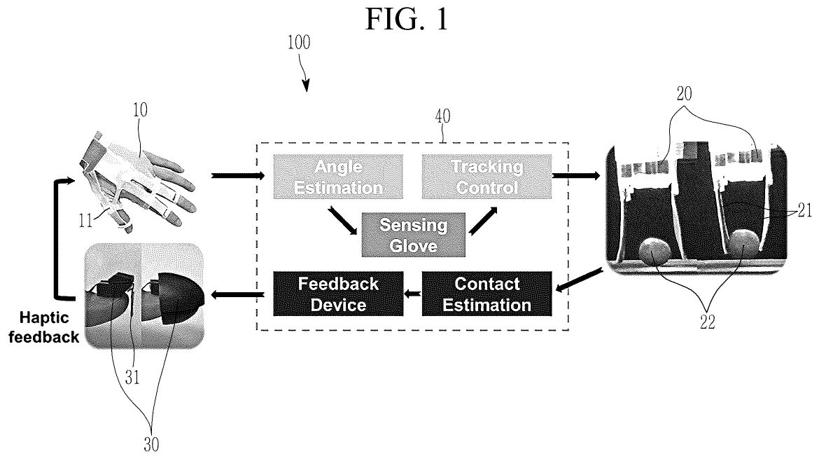

FIG. 1 is a schematic view showing the configuration of a haptic interaction system according to an embodiment.

Referring to FIG. 1, haptic interaction system 100 may include sensing glove 10 that is worn on the user's hand and detects fingers' movement, soft gripper 20 that is operated in accordance with the user's fingers' movement, tactile device 30 that provides contact feedback of soft gripper 20 to the hand of the user, and haptic interface 40 that generates tracking control of synchronizing the movement of the fingers of the user with the movement of soft gripper 20, and provides tactile feedback signal from the physical contact of soft gripper 20 with object 22 to tactile device 30. Each component in the haptic interaction system 100 is connected to other components through the haptic interface 40 and operates cohesively within a closed loop.

Sensing glove 10 may be made of a similar shape and material as a regular glove, and may be made of a flexible and durable material. For example, the sensing glove 10 may be made of various types of natural or synthetic fibers, an elastic resin material, natural or synthetic rubber, or, for example, silicone resin. The shape of sensing glove 10 is not particularly limited, but as shown in FIG. 1, the sensing glove 10 is configured to cover the back of the user's hand, the thumb and index finger, and optionally a portion of the middle finger, and the terminal portions of the thumb, index finger, and, optionally, middle finger may be open.

Sensor 11 may be attached to the joint portion corresponding to the thumb and index finger of the sensing glove 10. For example, one side of the sensor 11 is attached to the joint area of the thumb and index finger of the sensing glove 10, and the other side may be fixed to the adjacent proximal bone of the thumb and index finger of the user by a velcro strip or the like.

Sensor 11 may be, for example, a strain sensor that detects movement of the user's finger joints. The strain sensor may be, for example, a metal strain sensor that is liquid at room temperature, and may include, for example, a eutectic gallium indium (EGaIn) alloy. Sensor 11 may be stretched due to the rotation radius of the finger joint when the user wearing sensing glove 10 bends the thumb or index finger, and the signal of the sensor in accordance with the degree of stretching may have change in electrical resistance. The change in electrical resistance of sensor 11 may be transmitted to the haptic interface 40. Haptic interface 40 may evaluate the changes in the electrical resistance of sensor 11 and generate tracking control that synchronizes the movement of the user's fingers with the movement of a pair of sensor-integrated actuators 21 mounted on soft gripper 20. Through this, commands according to the movements of the user's thumb and index finger can be transmitted to each of the pair of sensor-integrated actuators 21.

In addition, haptic interface 40 may evaluate contact between the pair of sensor-integrated actuators 21 mounted on the soft gripper 20 and the object 22 placed therebetween by sensing a change in electrical resistance of the sensor included in the sensor-integrated actuator 21 of soft gripper 20 when a pair of sensor-integrated actuators 21 mounted on the soft gripper 20 contacts the object in accordance with the command according to the movement of the user's finger. From this, the haptic interface 40 may generate a feedback signal indicating contact between the sensor-integrated actuator 21 of the soft gripper 20 and the object 22 and transmits it to the tactile device 30 mounted on the user's finger.

As shown in the left below in FIG. 1, tactile device 30 may be mounted on the user's fingertip, for example, a fingernail, or may be configured in the form of a thimble to be inserted into the user's fingertip. As mentioned above, sensing glove 10 may cover the user's thumb, index finger, and optionally the middle finger, with the ends of the thumb, index finger, and optionally the middle finger being open. The open end of sensing glove 10 may expose the extremities of the user's thumb, index finger, and optionally the middle finger, tactile device 30 may be mounted on the user's exposed fingertips in the form described above. Tactile device 30 may include an iEAP actuator, and the iEAP actuator may vibrate to deliver tactile feedback regarding the contact between the soft gripper 20 and the object 22 to the user's fingertips when receiving a contact feedback signal between the sensor-integrated actuator 21 of the soft gripper 20 and the object 22 from the haptic interface 40.

Although the shape of the sensing glove 10, the material and attachment location of the sensor 11, and the shape and mounting location of the tactile device 30 have been described above, they are not limited to these examples, and the embodiments of the present invention may have various modifications and changes. For example, the sensing glove 10 may be configured to cover only some fingers, such as the thumb, index finger, and/or middle finger, or to cover all of the user's fingers, depending on the user's convenience. The finger ends of the sensing glove 10 may be closed rather than open. In addition, the tactile device 30 may not be limited to the form shown in FIG. 1, and can be modified into various forms that can be fixed in any shape to any position of the user's fingertips, or any part of the fingers or palm.

Meanwhile, the sensor-integrated actuator 21 included in the soft gripper 20 may include an ionic electroactive polymer (iEAP) actuator and a strain sensor coupled thereto. The strain sensor may include the same EGaIn sensor as the sensor 11 attached to the sensing glove 10. The sensor included in the sensor-integrated actuator 21 may receive a tracking control signal according to the movement of the user's finger generated by the haptic interface 40, and render the iEAP actuator coupled thereto to operates in conjunction with the movement of the user's finger. For example, when an object 22 is placed between a pair of sensor-integrated actuators 21 of the soft gripper 20 and a user wearing sensing gloves 10 pinches the thumb and index finger, a pair of opposing sensor-integrated actuators 21 of the soft gripper 20 are also bent inward so that the lower ends of the sensor-integrated actuators 21 approach each other in the same manner as the movement of the user's fingers. If the user continues to bring the thumb and index finger closer together, the lower ends of the pair of sensor-integrated actuators 21 of the soft gripper 20 also bend further inward, and finally, they come into contact with an object 22 placed therebetween. In this case, physical contact between the pair of sensor-integrated actuators 21 and the object 22 causes a change in the electrical resistance of the EGaIn sensor included in the sensor-integrated actuator 21, haptic interface 40 can evaluate the physical contact between the sensor-integrated actuator 21 and the object 22 by evaluating the change in electrical resistance of the sensor. Accordingly, haptic interface 40 generates a contact feedback signal by physical contact between the sensor-integrated actuator 21 and the object 22 and transmits it to the tactile device 30 mounted on the user's hand.

In FIG. 1, two states of soft gripper 20 are shown, i.e., in left, the soft gripper 20 does not contact the object 22 placed between the pair of sensor-integrated actuators 21 of the soft gripper 20, and in right, as the user makes a movement of pinching the thumb and index finger, the pair of sensor-integrated actuators 21 move closer to each other in conjunction with the use's movement, such that the pair of sensor-integrated actuators 21 comes into contact with the object 22 placed therebetween.

As described above, haptic device 30 is also equipped with an iEAP actuator 31, which may include the same actuator as the iEPA actuator included in the sensor-integrated actuator 21 mounted on the soft gripper 20. The iEAP actuator 31 vibrates by a contact feedback signal transmitted from the haptic interface 40, thereby feedbacking the contact state between the sensor-integrated actuator 21 of the soft gripper 20 and the object 22 to the user. In this case, the user can decide subsequent actions. For example, the user may move the thumb and index finger of the hand wearing the sensing glove 10 to cause the soft gripper 20 to lift object 22 up, to transport the lifted object 22 to a pre-determined location, or the object 22 transported to the pre-determined location can be allowed to escape from the soft gripper 20. As long as the object 22 does not escape from the soft gripper 20, that is, while the object 22 and the pair of sensor-integrated actuators 21 maintain physical contact, the iEAP actuator 31 of the haptic device 30 may continuously deliver tactile feedback signals to the user's hands. Accordingly, even though the user does not check the contact state between the soft gripper 20 and the object 22 through vision, the user can check whether the soft gripper 20 and the object 22 are in physical contact through tactile sense, and accordingly subsequent actions can be decided and executed.

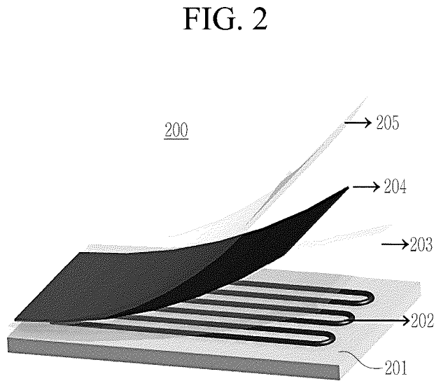

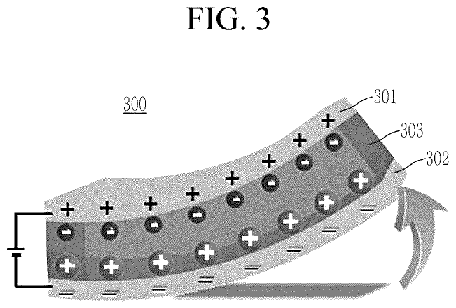

Hereinafter, referring to FIG. 2 and FIG. 3, the structures of the sensor-integrated actuator 21 mounted on the soft gripper 20 and the iEAP actuator 31 included in the tactile device 30 will be described in detail.

FIG. 2 is an exploded perspective view schematically showing the structure of a sensor-integrated actuator according to an embodiment.

Referring to FIG. 2, sensor-integrated actuator 200 includes a strain sensor 202 placed on the lower support 201, a first elastomer film 203 placed on the strain sensor 202, iEAP actuator 204 placed on the first elastomer film 203, and a second elastomer film 205 placed on the iEAP actuator 204. The lower support 201 may be made of any flexible material capable of supporting and/or encapsulating the strain sensor 202, for example, a third elastomer film. Strain sensor 202 may include any strain sensor, for example, a eutectic gallium-indium (EGaIn) alloy, which is in a liquid state at room temperature. The strain sensor 202 may be prefabricated in an arbitrary shape and then placed on the lower support 201, or may be printed directly on the lower support 201 by using a EGaIn alloy, which is in a liquid state at room temperature. The shape of the strain sensor 202 is not particularly limited, but the contact area with the iEAP actuator 204 is large, and the sensor-integrated actuator 200 may be formed in a light, thin, and bendable form. In the sensor-integrated actuator 200, the iEAP actuator 204 may substantially be encapsulated by the first elastomer film 203 and the second elastomer film 205. The performance of the sensor-integrated actuator 200 and/or the haptic interaction system 100 including the same may inevitably be reduced by the insertion of the encapsulation layer. Accordingly, in order to effectively drive the sensor-integrated actuator 200 and the haptic interaction system 100 including same, it is important to achieve high force and large deformation of the iEAP actuator at high frequencies. The iEAP actuator included in the sensor-integrated actuator 200 according to one embodiment has high mechanical strength and includes a specific bifunctional polymer electrolyte membrane through which ions can diffuse at a high speed.

FIG. 3 is a schematic diagram schematically showing the structure of the iEAP actuator included in the sensor-integrated actuator of FIG. 2.

Referring to FIG. 3, the iEAP actuator 300 includes a pair of opposing flexible electrodes 301 and 302, and a polymer electrolyte membrane 303 interposed between the pair of flexible electrodes 301 and 302. The polymer electrolyte membrane 303 may include a polymer comprising a structural unit represented by Chemical Formula 1, and an ionic liquid:

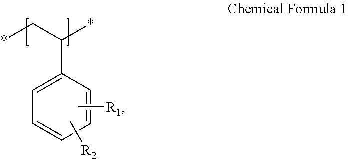

wherein in Chemical Formula 1,
R₁ and R₂ may, each independently, be —OH, —COOH, —SO₃H, —PO₃H₂, —NH₂, imidazolyl group, —SO₂N(X₁)SO₂CF₃, or —CN, wherein X₁ may be hydrogen, or a substituted or unsubstituted C₁ to C₃₀ alkyl group, and
R₁ and R₂ may be located adjacent to each other.

For example, R₁ and R₂ may, each independently, be positioned at ortho and meta positions, or meta and para positions, respectively, based on the position where the phenyl group is bonded to the main chain in Chemical Formula 1.

The Chemical Formula 1 may be represented by Chemical Formula 1-1 or Chemical Formula 1-2:

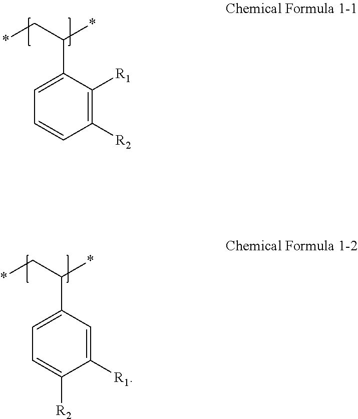

In Chemical Formula 1-1 and Chemical Formula 1-2,
R₁ and R₂ may, each independently, be the same as defined in Chemical Formula 1.

In Chemical Formula 1, R₁ and R₂ may, each independently, be —OH, —SO₃H, —PO₃H₂, or an imidazolyl group. For example, R₁ and R₂ may, each independently, be —OH or —SO₃H. For example, one of R₁ and R₂ may be —OH, and the other may be —SO₃H.

In an example, the Chemical Formula 1 may be represented by Chemical Formula 2, and for example, the polymer may be polystyrene-3-hydroxy-4-sulfoacid (PS-3H₄S) composed of the structural units represented by Chemical Formula 2:

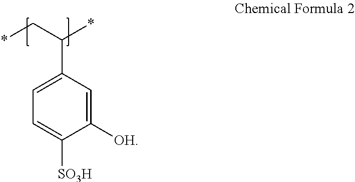

The ionic liquid may include a cationic liquid, anionic liquid, neutral liquid, or a combination thereof.

In an example, the cationic liquid may include imidazolium, pyrrolidinium, piperidinium, alkylmethylimidazolium, or a combination thereof;
the anionic liquid may include trifluoroacetate([tfa]⁻), trifluoromethanesulfonate ([CF₃SO₃]⁻), bis(fluorosulfonyl)imide ([N(SO₂F)₂]⁻), bis(trifluoromethanesulfonyl)imide ([N(SO₂CF₃)₂]⁻), Dicyanamide ([N(CN)₂]⁻), tetracyanoborate ([B(CN)₄]⁻), dihydrogenphosphate ([H₂PO₄]⁻), hydrogen sulfate ([HSO₄]⁻), or a combination thereof; and
the neutral liquid may include 1-ethyl-3-methylimidazolium-bis(trifluoromethylsulfonyl)imide (EMITFSI), 1-methyl-3-propylimidazolium iodide (PMII), 1-ethyl-3-methylimidazolium tetrafluoroborate (EMIBF4), 1-ethyl-3-methylimidazolium trifluoromethanesulfonate (EMITf), 1-ethyl-3-methylimidazolium hydrogensulfate (EMIHSO4), N-methyl-N-butylpyrrolidinium-bis(trifluoromethanesulfonyl) imide (PYRTFSI), or a combination thereof.

For example, the ionic liquid may include a mixture containing the cationic liquid and the anionic liquid at a molar ratio of 1:10 to 10:1, for example, 1:1 to 5:1. For example, the cationic liquid may be EMIm⁺ (1-ethyl-3-methylimidazolium), and the anionic liquid may be TFSI⁻ (bis(trifluoromethylsulfonyl)imide), but is not limited thereto.

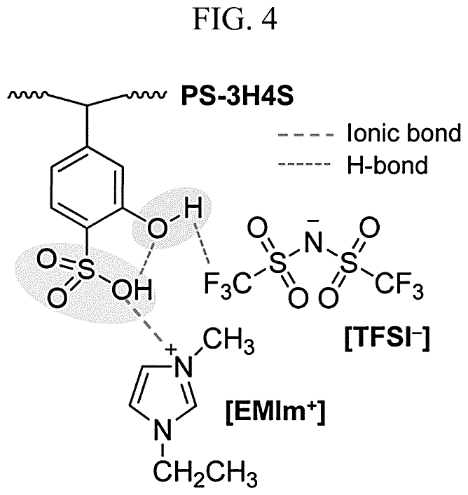

In the polymer electrolyte membrane 303, as shown in Chemical Formula 1 above, the polymer including a styrene structural unit that contains two specific functional groups at adjacent positions, such as R₁ and R₂, may form ionic bonds and/or hydrogen bonds between the R₁ and R₂ functional groups, and/or between each of the functional groups and cation and/or anion contained in the ionic liquid. For example, in the structural unit represented by Chemical Formula 2, the —SO₃H group can form an ionic interaction with the EMIm⁺ ion in the ionic liquid, and the —OH group can form an additional hydrogen bond with the TFSI⁻ ion. FIG. 4 schematically shows the ionic interaction and hydrogen bonding relationship between the functional groups of the polymer (PS-3H4S) and ions in the ionic liquid.

Due to the interactions among the functional groups of the polymer and the ions in the ionic liquid as described above, the polymer electrolyte membrane 303 has high mechanical properties, as well as excellent ion dissociation and ion aggregation inhibition effects. Because of this, the polymer electrolyte membrane 303 may provide an iEAP actuator with excellent drivability and mechanical properties even in a low-voltage environment. In addition, the polymer including a styrene structural unit that contains the specific functional groups induces chemical interaction between the functional groups, and suppressing electrostatic interaction with the ions in the ionic liquid when manufacturing a polymer electrolyte membrane 303 containing the ionic liquid. As a result, the ionic liquid is not uniformly mixed with the polymer and forms an ionic layer that fills the spaces between the high-strength polymer domains. Accordingly, a well-connected rod-shaped ion channel is formed between polymer domains, which has the advantage of achieving decoupling of polymer chain behavior and ion conduction. In addition, the polymer electrolyte membrane 303 may exhibit excellent proton conduction properties even at low temperatures, has excellent ionic conductivity and storage modulus, and has excellent mechanical properties such as a high glass transition temperature.

The ion transport and mechanical properties of the polymer electrolyte membrane 303 may be controlled by the loading amount of cations and anions contained in the ionic liquid, and the ion transport and mechanical properties are generally inversely proportional to the loading amount of the cations and anions. That is, as the content of ionic liquid in the polymer electrolyte membrane 303 increases, ion transport characteristics, that is, electrical conductivity, as well as shear modulus, may decrease. For example, in a polymer electrolyte containing polystyrene-3-hydroxy-4-sulfoacid (PS-3H₄S) as a polymer and [EMIm⁺][TFSI⁻] as an ionic liquid, the polymer electrolyte membrane 303 containing about 60% by weight of [EMIm⁺][TFSI⁻], which corresponds to a molar ratio of the ionic liquid to [—SO₃H] groups of the polymer (PS-3H4S) of about 1:1, may have an ionic conductivity of about 0.4 mS/cm at about 22° C., and a shear modulus of about 3.3 MPa. However, in the polymer electrolyte membrane, when the content of the ionic liquid increases beyond the above range, the mechanical strength of the polymer electrolyte membrane rapidly decreases and the polymer electrolyte membrane may become a non-self-supporting electrolyte layer.

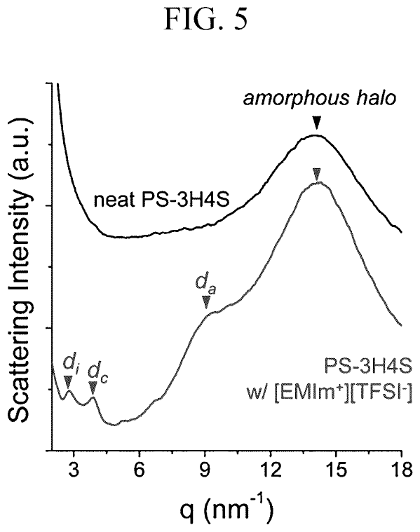

Meanwhile, the morphology of the polymer, such as PS-3H4S, can be known through an X-ray scattering experiment. FIG. 5 shows the X-ray scattering profiles of pure PS-3H4S (neat PS-3H4S) and the PS-3H4S containing 60 wt % of [EMIm⁺][TFSI⁻]. From FIG. 5, it is noted that the PS-3H4S containing 60 wt % of [EMIm⁺][TFSI⁻] forms an ion channel having a width (dᵢ) of about 2.3 nm and containing ion clusters spaced about 1.6 nm (d_{c}) apart. Additionally, from FIG. 5, the interaction between TFSI⁻ anions (dₐ) at a distance of about 0.7 nm can also be clearly seen, indicating well-ordered ionic moieties in the nanoscale ion channel.

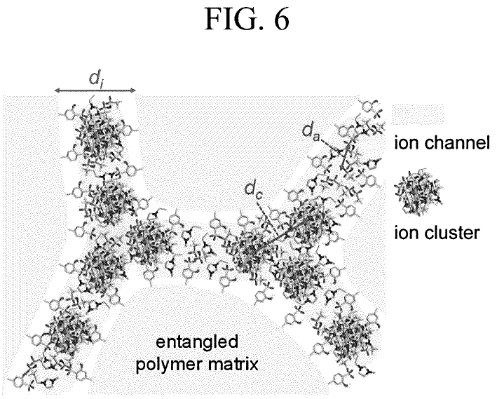

FIG. 6 is a schematic diagram schematically showing the structure of a polymer electrolyte membrane including PS-3H4S polymer matrices and ion channels formed between these matrices estimated from FIG. 5. As shown in FIG. 6, clusters of ions present in the ionic liquid are connected at regular intervals in the ion channel between the polymer matrices, and some ions in these ion clusters and some functional groups of the polymer in the polymer matrix may form ionic interactions or hydrogen bonds.

The haptic interaction system 100 and/or sensor-integrated actuator 200 according to one embodiment include the polymer electrolyte membrane 303 as described above, thereby providing excellent drivability even in a low-voltage environment and improved switching speed, as well as improved stability of high lithium plating/stripping behavior.

The manufacture of the polymer electrolyte membrane 303 is described in detail in the inventor's previous Korean Patent Application No. 2023-0017735 (filed on Feb. 10, 2023), the entire contents of which are incorporated herein by reference.

As can be seen from the examples and comparative examples described later, upon comparing the polymer electrolyte membrane 303 containing PS-3H4S polymer and an ionic liquid ([EMIm⁺][TFSI⁻]) and a polymer electrolyte membrane containing PVdF-HFP (poly (vinylidene fluoride-co-hexafluoropropylene)) polymer and an ionic liquid ([EMIm⁺][TFSI⁻]), which was used in manufacturing conventional iEAP actuator, the specific capacitance of the polymer electrolyte membrane 303 included in the iEAP actuator according to an embodiment is much higher than that of the polymer electrolyte membrane containing the PVdF-HFP polymer, for example, about 4 times or more at a frequency of 10 Hz. Without wishing to be bound by a specific theory, but as described above, it is believe that the polymer in the polymer electrolyte membrane 303 included in the iEAP actuator according to an embodiment includes the structural unit represented by Chemical Formula 1 that contains specific functional groups, and thus, the polymer electrolyte membrane 303 according to an embodiment may efficiently dissociate and/or transfer ions through the effective interactions between the functional groups, as well as between the functional groups and ions included in the ionic liquid.

Meanwhile, at least one of the pair of flexible electrodes 301 and 302 of the polymer electrolyte membrane 300 may be a single-walled carbon nanotube (SWCNT) electrode, a multi-walled carbon nanotube (MWCNT) electrode, or a PEPOT:PSS (poly (3,4-ethylenedioxythiophene):polystyrene sulfonate) conductive polymer electrode, gold (Ag) electrode, platinum (Pt) electrode, or a combination thereof, for example, at least one of the pair of flexible electrodes 301 and 302 may include PEPOT:PSS, and for example, the pair of flexible electrodes 301 and 302 may both be made of PEPOT:PSS, but are not limited thereto.

Hereinafter, a method of manufacturing of a sensor-integrated actuator according to an embodiment, a method of constructing a haptic interaction system including the same, and the performance and effects of the manufactured sensor-integrated actuator will be described in detail through the examples. However, the following examples are only examples for explaining the above-mentioned embodiments, and the scope of the present invention is not limited by these examples. It will be understood that the matters described in the claims attached to the specification of the present application and all changes, modifications, and/or improvements that can be made by those skilled in the art fall within the scope of the present invention.

### EXAMPLES

### Synthesis Example 1: Synthesis of Polystyrene-3-hydroxy-4-sulfoacid (PS-3H4S)

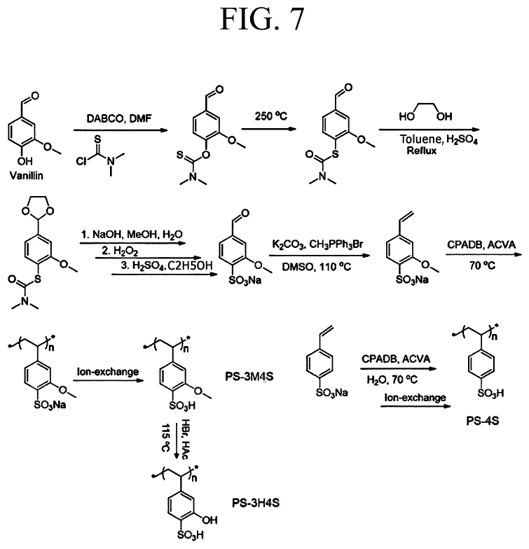

Polystyrene-3-hydroxy-4-sulfoacid was synthesized as a polymer forming a polymer electrolyte membrane of an ionic electroactive polymer (iEAP) actuator according to an embodiment. The method for synthesizing the polymer is described in detail in the examples of Korean Patent Application No. 2023-0017735, the contents of which are hereby incorporated by reference in their entirety. Additionally, a reaction scheme of synthesizing the polymer is shown in FIG. 7.

Referring to FIG. 7, vanillin, as a starting material, is reacted with dimethylthiocarbamoyl chloride in an organic solvent (DMF: dimethyl formamide) in the presence of DABCO (1,4-diazabicyclo[2.2.2]octane) to produce 3-methoxy-4-thiocarbamoyl benzaldehyde, which is subsequently heated to 250° C., refluxed in toluene with ethylene glycol and sulfuric acid through Dean-Stark until no water was produced. Subsequently, the product is added to Na₂CO₃, extracted as an oil phase by using water and ethyl acetate, and dried to obtain 3-methoxy-4-thiocarbamoyl benzaldehyde protected with an acetal group.

Afterwards, 3-methoxy-4-thiocarbamoyl benzaldehyde protected with an acetal group is dissolved in a mixture of methanol and water, NaOH is added thereto to perform a hydrolysis reaction. Then, the reactant is cooled and hydrogen peroxide (H₂O₂) is added thereto, stirred, and dried. The obtained dried product is dissolved in a mixture of sulfuric acid and ethanol at room temperature, then ethanol is further added and dried to obtain 3-methoxy-4-sodium sulfonate benzaldehyde.

By converting the formyl group of the obtained 3-methoxy-4-sodium sulfonate benzaldehyde to a vinyl group through Wittig reaction by reacting with K₂CO₃ and CH₃PPh₃Br in DMSO (Dimethyl Sulfoxide) at 110° C., 3-methoxy-4-Sodium sulfonate styrene monomer is obtained. The obtained 3-methoxy-4-sodium sulfonate styrene monomer is mixed with 4-cyanopentanoic acid dithiobenzoate (CPADB) and 4,4′-azobis(4-cyanovaleric acid) (ACVA), and the mixture is reacted by heating to 70° C. to conduct a Reversible Addition Fragmentation Chain-Transfer (RAFT) polymerization reaction to product polystyrene (3-methoxy-4-sodium sulfonate), which is subsequently ion-exchanged to produce polystyrene(3-methoxy-4-sulfoacid) (PS-3M4S).

The obtained PS-3M4S is reacted with acetic acid and hydrobromic acid by stirring in an oil bath at 115° C. to deprotect the methoxy group therefrom, whereby the final product, polystyrene-3-hydroxy-4-sulfoacid (PS-3H4S), is obtained. Molecular weight of the obtained PS-3H4S was 8 kg/mol, and polydispersity was 1.1, as determined by ¹H-NMR (¹H-Nuclear Magnetic Resonance, Bruker instrument, at 500 MHz, in DMSO-d₆) and Size Exclusive Chromatography (SEC, Waters Breeze 2HPLC, THF eluent).

### Preparation Example 1: Fabrication and Characterization of Polymer Electrolyte Membranes

The PS-3H4S polymer prepared in Synthesis Example 1 and the ionic liquid ([EMIm⁺][TFSI⁻], ≥97%, Sigma-Aldrich) are dissolved in methanol. After stirring at 25° C. for 6 hours, the mixture is dried at 40° C. for one day, and then vacuum-dried at 40° C. for 12 hours to prepare a polymer electrolyte membrane (also called ‘PS-3H4S electrolyte membrane’).

Through-plane ionic conductivity and specific capacitance of the PS-3H4S electrolyte membrane at different ionic liquid loading amounts are measured using electrochemical impedance spectroscopy (Solartron 1260A, AMETEK, Inc.) in an argon-filled glove box in the frequency range of 1 Hz to 106 Hz. The dimension of the membrane was 1.5 cm×1.5 cm×500 μm. The shear modulus of the membrane is measured in the linear viscoelastic region (strain 0.1%, frequency 0.5 rad s⁻¹) using a rheometer (Discovery HR-20, TA Instruments) equipped with an 8 mm diameter parallel plate. X-ray scattering experiments are performed using an X-ray diffractometer (Miniflex 600, Rigaku) with a wavelength of 0.154 nm. For in situ attenuated total reflectance Fourier transform infrared (ATR-FTIR) spectroscopy experiments (PerkinElmer), the freestanding PS-3H4S electrolyte membrane with a thickness of 100 μm was coated with about 20 nm-thick gold electrodes and dc voltage of 1.5 V was applied.

### Preparation Example 2: Preparation and Characterization of PEDOT:PSS Electrodes

PEDOT:PSS electrodes are prepared by casting of aqueous PEDOT:PSS dispersion (1.3 wt %, PH1000, Celvios) containing 5 wt % dimethyl sulfoxide (anhydrous, >99.9%, Sigma-Aldrich) onto oxygen plasma treated polydimethylsiloxane substrate, dried at 60° C. for 12 hours, and peeling off a free-standing PEDOT:PSS film from the substrate.

The optimized thickness of PEDOT:PSS electrodes that maximizes actuation performance was 12 μm. Tensile tests of PEDOT:PSS films were performed using universal testing machine (UTM, ST-1003, SALT). Current-voltage profiles and cyclic voltammetry of PEDOT:PSS electrodes were measured by electrochemical impedance spectroscopy (VersaSTAT3, Princeton Applied Research, AMETEK, Inc.). All electrode characterizations were performed at laboratory ambient atmosphere (average RH of 22% and temperature of 21° C.). As a result of the measurement, the conductivity of the prepared PEDOT:PSS membrane was about 546 S/cm, and the mechanical strength (Young's modulus) was about 1.5 Pa.

### Preparation Example 3: Fabrication of Ionic Electroactive Polymer (iEAP) Actuators

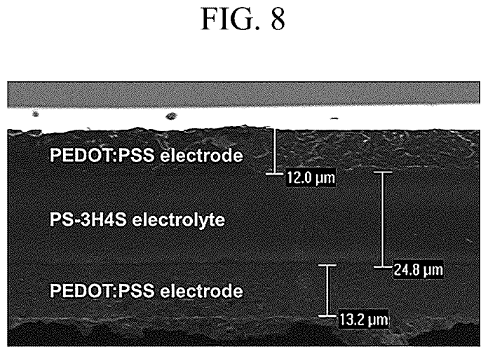

The PS-3H4S electrolyte membrane prepared in Preparation Example 1 is hot pressed at 60° C. to obtain a free-standing membrane having a thickness of about 25 μm. After sandwiching the PS-3H4S electrolyte membrane with a pair of the PEDOT:PSS electrodes prepared in Preparation Example 2, additional heat of 60° C. was applied for 30 minutes to improve interfacial properties of the obtained a trilayer iEAP actuator. Thickness of each layer in the obtained iEAP actuator was measured using scanning electron microscope (SEM, Philips, XL30 FEG) under a 5 keV accelerating voltage. The SEM image of the iEAP actuator is shown in FIG. 8.

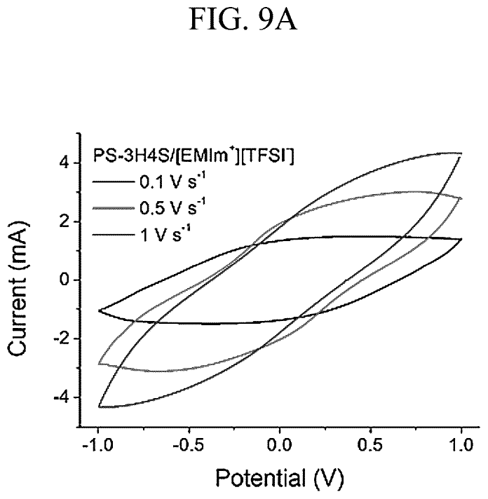

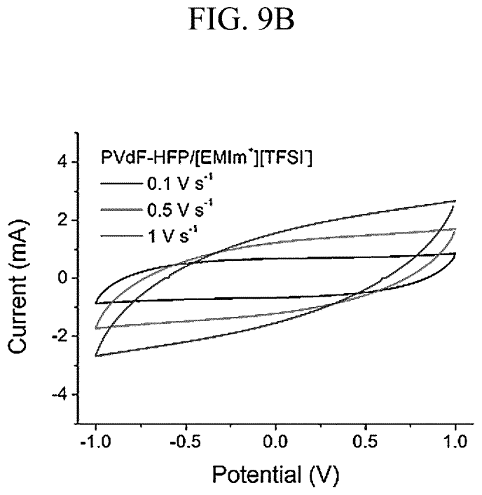

Meanwhile, the specific capacitances of the obtained iEAP actuator and an iEAP actuator manufactured using PVdF-HFP polymer, instead of PS-3H4S polymer, are measured and compared, as shown in FIG. 9A and FIG. 9B.

The graphs shown in FIG. 9A are the current-voltage curves of the iEAP actuator prepared by sandwiching a polymer electrolyte membrane made from PS-3H4S polymer and [EMIm⁺][TFSI⁻] ionic liquid between PEDOT:PSS electrodes according to this preparation example, while the graphs shown in FIG. 9B are those of the iEAP actuator prepared by sandwiching a polymer electrolyte membrane made from PVdF-HFP polymer, instead of PS-3H4S polymer, and [EMIm⁺][TFSI⁻] ionic liquid between PEDOT:PSS electrodes.

As shown from FIG. 9A and FIG. 9B, the iEAP actuator according to this preparation example has much more higher specific capacitances than the iEAP actuator prepared by using the PVdF-HFP polymer (114.3 mF/cm vs. 89.3 mF/cm under a scan rate of 0.1 V/s in the potential window of ±1V to −1V).

### Preparation Example 4: Fabrication of EGaIn Sensor

Uncured silicone elastomer (Ecoflex 00-30, Smooth-On) and white pigment (Silc Pig, Smooth-On) were mixed in a mass ratio of 1:0.05. Using a film applicator (Elcometer 4340, Elcometer), this mixture was applied onto a glass slide and cured at 60° C. for 30 min. This yielded a silicone substrate with about 350 μm thickness. Subsequently, EGaIn channel was directly printed onto the surface of the silicone substrate using an automatic pneumatic dispensing system (Shotmaster 300ΩX & SuperΣ CMIII V2, Musashi), a laser displacement sensor (LK-G32, Keyence), and a 300 μm needle. Next, the EGaIn channel was covered with uncured silicone elastomer and subjected to thermal curing at 60° C. for 30 min. Finally, the channels were wired with 30 AWG wires and silicone adhesive (Sil-Poxy, Smooth-On).

### Example 1: Fabrication and Characterization of Sensor-Integrated iEAP Actuator

Copper electrode was fixed to the elastomer surface covering the EGaIn sensor prepared in Preparation Example 4 using a silicone adhesive and physically attached to the iEAP actuator fabricated in Preparation Example 3 using a silver paste. The opposite electrode was connected in the same way. After drying the silver paste, the uncured silicone elastomer (Ecoflex 00-30, Smooth-On) was poured on to the iEAP actuator layer, followed by doctor blade coating to have a thickness of about 50 μm and curing at 60° C. for 1 hour.

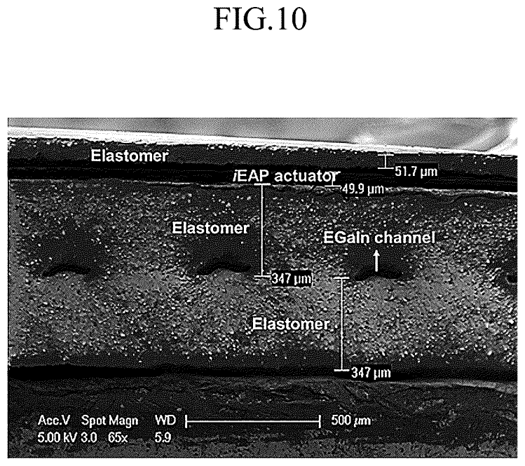

A cross section of the obtained sensor-integrated actuator was measured by using a scanning electron microscope (SEM, Philips, XL30 FEG), and the results are shown in FIG. 10.

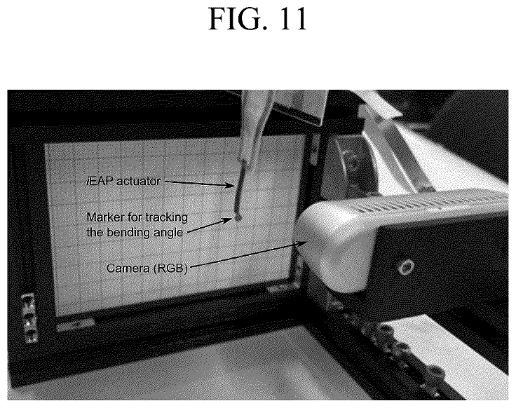

The sensor-integrated iEAP actuator was actuated by a customized electric circuit, generating programmable voltage output between −3 and 3 V. At the same time, the sensor signal was collected by applying constant current (16 mA) through the EGaIn channel and measuring the voltage between the two ends. The bending motions of the sensor-integrated iEAP actuator were recorded in RGB frames by a camera (Intel RealSense D435, Intel) while applying sinusoidal input voltages of various amplitudes (0.5, 1.0, 1.5 V) in the frequency range of 0.05 Hz to 1 Hz at ambient conditions. A colored marker (diameter of about 2 mm) was attached to the end of the iEAP actuator and the position of the marker was tracked by a motion analysis software (Proanalyst, Xcitex) to calculate the true (reference) bending angle. For all actuation measurements, the relative position and orientation between the camera and the iEAP actuators were fixed by employing a customized test stand (Refer to FIG. 11).

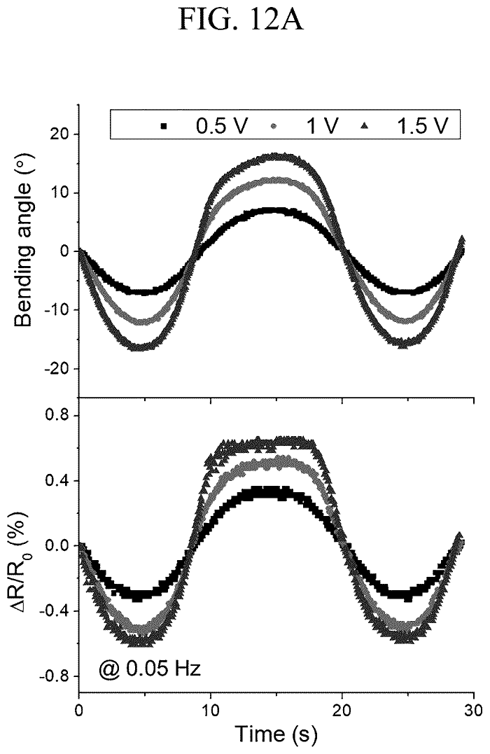

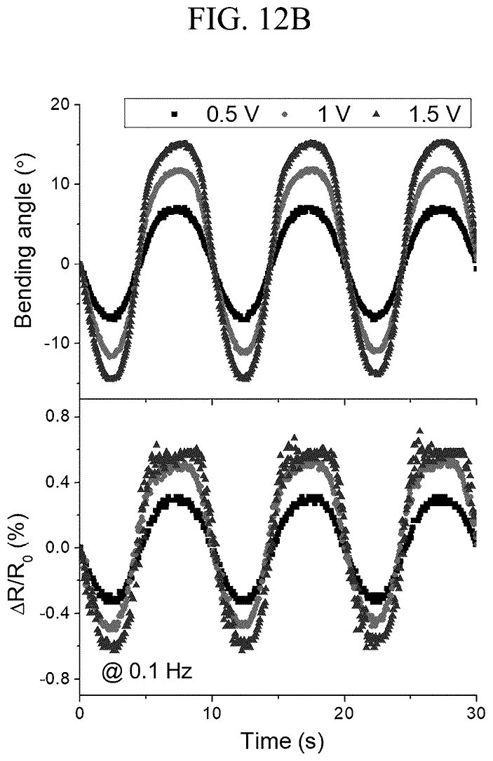

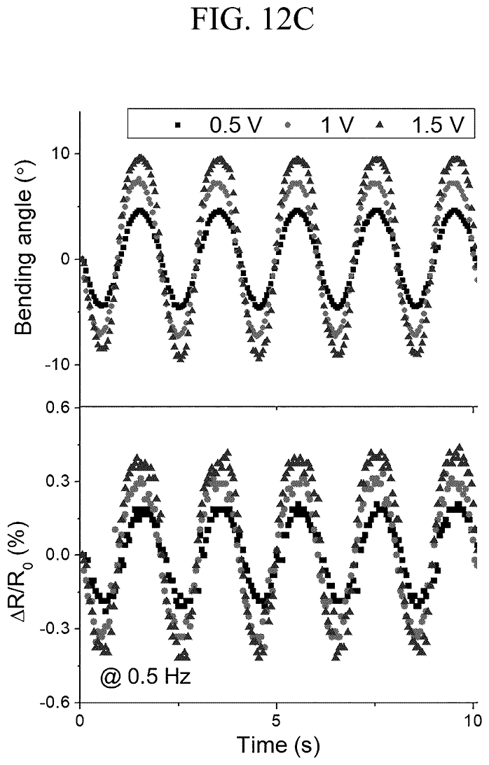

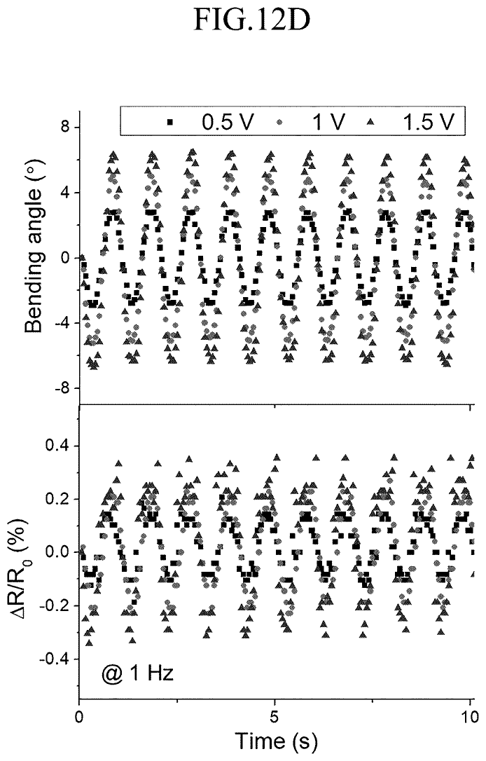

FIG. 12A to FIG. 12D show graphs of the bending angles (or bending response) and sensor signals (ΔR/R₀) (or sensitivity) of the sensor-integrated iEAP actuator measured by using the customized test stand under sine voltages of 0.5 V, 1 V, and 1.5 V at frequencies of 0.05 Hz (FIG. 12A), 0.1 Hz (FIG. 12B), 0.5 Hz (FIG. 12C), and 1 Hz (FIG. 12D).

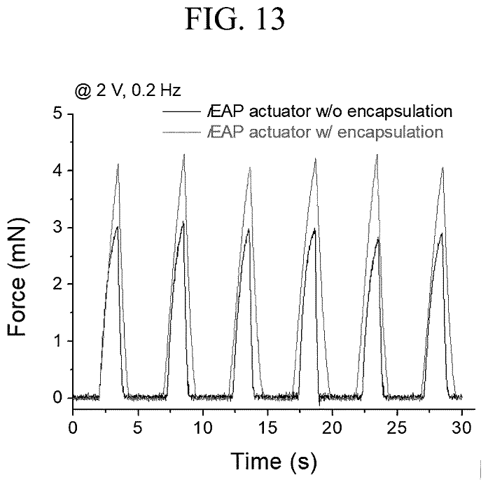

Meanwhile, the results of measuring the forces of the iEAP actuator over time when the iEAP actuator is sealed with an elastomer and when it is not sealed are shown in FIG. 13. As shown in FIG. 13, the iEAP actuator sealed with an elastomer outputs bigger forces than the iEAP actuator without sealing, and maintains the same electrical and mechanical properties as the iEAP actuator without sealing, while not reducing the rate of response of the iEAP actuator without sealing.

### Example 2: Fabrication of the Haptic Feedback Device and Measuring the Force of the iEAP Actuator

### (1) Preparation of the Haptic Feedback Device

Copper electrode was fixed to the surface of the iEAP actuator (16 mm×3 mm) prepared in Preparation Example 3, followed by the encapsulation with about 80 μm thick ecoflex elastomer layer. In order to firmly anchor the haptic feedback device to the finger tip of the user, two parts, i.e., a bottom part configured to be mounted on a fingernail of a user and an upper part covering the bottom part were designed by a 3d printer (Mark Two, Markforged). Prepared bottom part was attached to the fingernail using a commercial double-sided tape, and the upper part was mechanically assembled with the bottom one to fix the electrode wire.

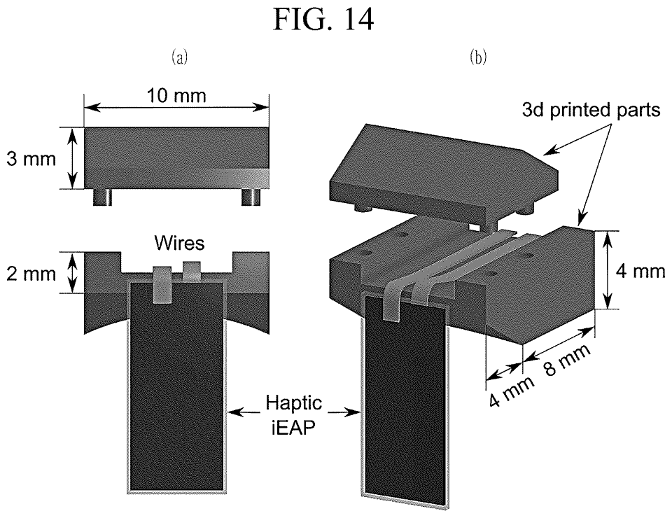

A front view (a) and a perspective view (b) of the upper part and the bottom part prepared by the 3d printer (Mark Two, Markforged) are shown in FIG. 14. As shown in FIG. 14, an iEAP actuator may be attached vertically to the end of the bottom part of the haptic feedback device.

(2) Measurement of Force of the iEAP Actuator

An iEAP actuator according to Preparation Example 3 was prepared as a strip having a size of 15 mm×2 mm, pinched at one end thereof with two stainless steel electrodes to prepare an actuator with a free length of 12 mm from the point in contact with the stainless steel electrodes. The generated forces of the iEAP actuator and haptic feedback device were measured using a LVS-5GA load cell (Kyowa Electronic Instruments, Japan, a maximum sensitivity of 50 mN). A step voltage of ±2 V at 10 Hz was applied to the actuators using electrochemical impedance spectroscopy (VersaSTAT3, Princeton Applied Research, AMETEK, Inc.) and output forces on the load cell were recorded with dynamic data acquisition software.

### Example 3: Fabrication of Sensing Glove

Wearable sensing glove is fabricated to measure the motions of thumb and index finger. Joint motion of each finger (thumb interphalangeal joint and index pr oximal interphalangeal joint) generates command for motion of each actuator (two fingers can independently teleoperate two actuators attached to the soft gripper). The EGaIn strain sensor according to Preparation Example 4 is placed at the join t of each finger so as to be stretched when the joint is bent due to its radius of rotation. One side of the sensor is attached to the fabric wearable glove and the other side of the sensor is anchored at the adjacent proximal bone with a strip of Velcro.

### Example 4: Fabrication and Interactive Teleoperation of Soft Gripper with Haptic Feedback Device

Two sensor-integrated iEAP actuators (20 mm×5 mm) prepared in Example 1 were placed facing each other with a 15 mm gap to fabricate a soft gripper. The gripper was fixed on the 2-dof moving stage to convey the ball from start point to goal point. The ball was made of polystyrene with a weight of about 50 mg. To simplify the system, the path of the gripper was set to advance towards the goal point. The user wearing sensing glove was asked to toggle a manual switch when he/she decided to start moving the gripper along the planned path. Range of the sensor signals from the sensing glove and the targeted maximum bending angles of the iEAP actuators were determined beforehand. The finger sensor signals and the bending angles were linearly mapped, enabling the calculation of the target bending angles for teleoperation from the user's joint motions. The haptic feedback device was attached to the user's thumb, which was activated to vibrate at 10 Hz when the “Interactive Multiple Model (IMM)” estimator detected the contact between the iEAP actuator and the ball. The entire demonstration including the teleoperation and the haptic feedback device was automatically operated by an integrated system except for the positioning of the gripper towards the goal point.

### Evaluation Methods

### (1) Finite Element Analysis (FEA)

FEA was conducted using a commercialized software (Abaqus, Dassault Systems) to investigate the effects of the silicone substrate thickness on the actuation performance and sensitivity of the sensor-integrated iEAP actuator. The lateral dimension of the sensor-integrated iEAP actuator was set to be 20 mm×5 mm while the thickness of the silicone substrate layer between the EGaIn channel and the iEAP actuator was varied from 0 to 1 mm with an increment of 0.1 mm. One end of the actuator was fixed, and a moment was applied to the other end to have the same internal energy of 0.0025 mJ. The displacement and strain along the length of the actuator were used to calculate the bending angle of the actuator and the change in resistance (sensitivity) of the embedded EGaIn channel. The material properties used in the analysis were determined experimentally. The Young's modulus of the iEAP actuator was 650 MPa and the Yeoh coefficients of the silicone elastomer were C₁=1.366e-02, C₂=−2.588e-04, and C₃=8.889e-05.

### (2) Tracking Control and Teleoperation

The estimation and control system was operated at 20 Hz. For characterization of the dynamics of the sensor-integrated iEAP actuator, bending angles and sensor signals were sampled under sinusoidal input voltages of various frequencies (0.05 Hz, 0.1 Hz, 0.2 Hz, 0.5 Hz, and 1 Hz) and amplitudes (0.5 V, 1.0 V, and 1.5 V). To reflect the hysteresis of the actuator under large input frequency, the augmented state defined by stacking three consecutive values in time was used. The linear fitted model was shown to describe the system.

For model predictive control, the prediction horizon and control horizon were chosen as 5 and 3, respectively. The calculated voltage input by the controller was clipped to ensure that the amplitude does not exceed 2 V. At the same time that the controller observed the sensor signal from the EGaIn resistance change, the bending angle of the iEAP actuator was also recorded by the camera as a control experiment for the purpose of evaluating the accuracy.

### (3) Interactive Multiple Model (IMM) Analysis

To identify the dynamics of the contact motion of the iEAP actuator with an object, a 3d printed hexahedron block was placed on the side of the actuator so that the actuator can touch the block when the voltage was applied. The initial probability estimate was chosen as μ=[0.5,0.5] and the transition matrix was designed as πᵢⱼ (i.e., i for free motion, j for contact), as defined below:

$${Π}_{ij} = [ \begin{matrix}0.99 & 0.01 \\ 0.0001 & 0.9999\end{matrix} ] .$$

### (4) Statistical Analysis

Characterization plots were made by Origin 8.5 and Inkscape software. To ensure reproducibility of the sensor-integrated iEAP actuator, measurements were performed thrice. The baseline subtraction of in situ ATR-FTIR spectra were conducted using the OMNIC software. SEC traces were normalized by refractive index signals and analyzed by the Empower Pro software. The actuation videos were trimmed and compressed by the Adobe Premiere Pro 2020 software.

### Evaluation Results

(1) Actuation and Sensing Characteristics of the Sensor-Integrated iEAP Actuator

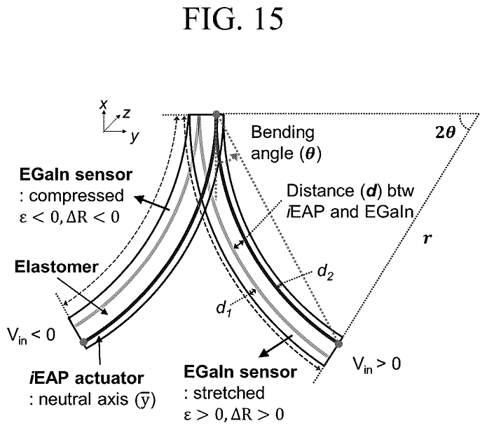

FIG. 15 shows a cross-sectional structure of the sensor-integrated iEAP actuator according to an embodiment, where the layers of the iEAP actuator and the EGaIn sensor are embedded in the elastomer matrix. We defined the input voltage (Vᵢₙ) as positive when the actuator bent in the stretching direction of the sensor layer. Therefore, the expansion of EGaIn when Vᵢₙ>0 causes an increase in the resistance (ΔR>0), whereas the contraction of EGaIn when the actuator bends in the opposite direction results in a decrease in the resistance (ΔR>0).

To amplify the sensor signal (ΔR/R₀), the inner elastomer layer between the EGaIn sensor layer and iEAP actuator layer was designed to be thick (d) to induce a greater strain (ε) at the same bending angle (θ). The bending angle from the vertical axis was measured by tracking the position of the actuator tip (marked by small dot in FIG. 15).

The modulus of the elastomer (about 0.07 MPa, Ecoflex 00-30, Smooth-On) is considerably lower than that of the iEAP actuator (about 650 MPa). Thus, assuming pure bending of the sensor-integrated actuator, its neutral axis (9) can be approximated to be equal to that of the iEAP actuator layer by following Equation (1):

$$\overline{y} = \frac{{E}_{E A P} {A}_{E A P} {\overline{y}}_{E A P} + {E}_{e l a} {A}_{e l a} {\overline{y}}_{e l a}}{{E}_{E A P} {A}_{E A P} + {E}_{e l a} {A}_{e l a}} = \frac{{\overline{y}}_{E A P} + ( {E}_{e l a} {A}_{e l a} / {E}_{E A P} {A}_{E A P} ) {\overline{y}}_{e l a}}{1 + ( {E}_{e l a} {A}_{e l a} / {E}_{E A P} {A}_{E A P} )} ≅ {\overline{y}}_{E A P} . \qquad ( 1 )$$

Because the thickness of the iEAP actuator (about 50 μm) is negligible relative to the total thickness (about 0.8 mm), ε of the sensor layer is determined by d as shown in Equation (2):

$$E = κ d = \frac{2 d θ}{{L}_{0}} \qquad ( 2 )$$

where κ is the bending curvature, and L₀ is the actuator length.

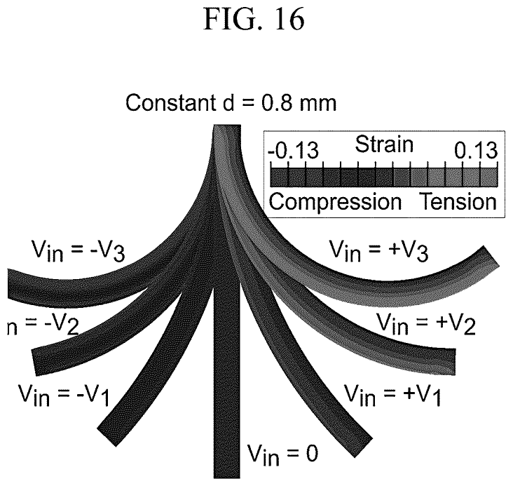

The model shown in FIG. 15 was verified using finite element analysis (FEA) software (Abaqus, Dassault Systems) (Methods). As shown in FIG. 16, at a fixed d value of 0.8 mm, the iEAP actuator layer is subjected to lowest strains (i.e., the neutral axis) at any pair of positive and negative Vᵢₙ values. In contrast, the sensor layer underwent the largest deformation (stretching, colored in gray; compression, colored in black) under a given Vᵢₙ. The effect of d on the sensitivity and bending angle of the sensor-integrated iEAP actuator was further investigated. The strain energy (U) of the sensor-integrated iEAP actuator under pure bending with bending moment M can be calculated by following Equation (3):

$$\begin{matrix}U = \frac{{M}^{2} {L}_{0}}{2 EI} = \frac{{( E 1 κ )}^{2} {L}_{0}}{2 EI} = \frac{1}{2} EI {κ}^{2} {L}_{0} \\ I = \int {y}^{2} d A = {\int }_{- {d}_{2}}^{d + {d}_{1}} {y}^{2} w d y = \frac{w}{3} \{ {( d + {d}_{1} )}^{3} + {d}_{2}^{3} \}\end{matrix} . \qquad ( 3 )$$

where E is the Young's modulus, I is the area moment of inertia of the actuator, d₁ is the thickness of the elastomer covering the EGaIn pattern, d₂ is the thickness of the elastomer covering the iEAP actuator, and w is the actuator width. Here, the thickness of the iEAP layer is ignored, and the strain energy (U) can be expressed by Equation (4):

$$U = \frac{2}{3} \frac{E w}{{L}_{0}} \{ {( d + {d}_{1} )}^{3} + {d}_{2}^{3} \} {θ}^{2} . \qquad ( 4 )$$

Given a constant energy input U₀ (i.e., constant electric energy), there is an inverse relationship between θ² and d³. Assuming a constant volume of the inner elastomer layer, the sensitivity of the EGaIn strain sensor (ΔR/R₀) can be calculated by Equation (5):

$$\frac{Δ R}{{R}_{0}} = {( 1 + ε )}^{2} - 1. \qquad ( 5 )$$

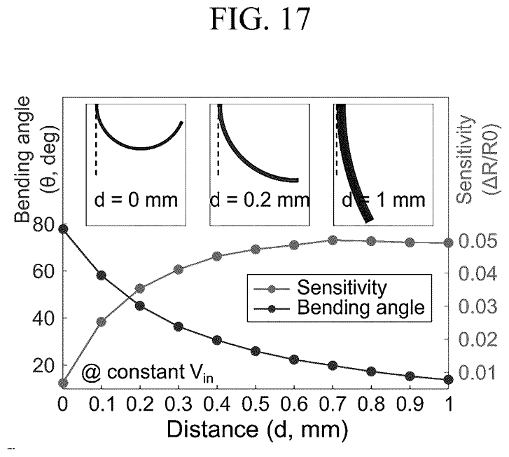

Using Equations (2), (4), and (5), the bending angles and sensitivities of the sensor-integrated actuators with different d values in the range of 0 to 1.0 mm were simulated under a constant energy input. As shown in FIG. 17, with the increase in d, the bending angle decreases, whereas ΔR/R₀ shows the opposite tendency. In other words, the greater distance of the EGaIn sensor layer from the iEAP actuator produced a higher sensitivity but a smaller bending angle. In the present example, the d value was optimized to about 350 μm to create a sufficient bending angle by the actuation of the thin iEAP actuator and the high sensitivity of the EGaIn sensor layer.

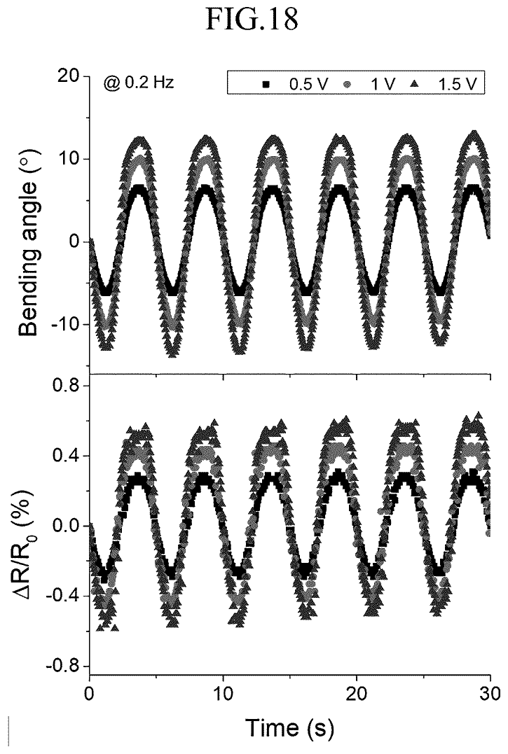

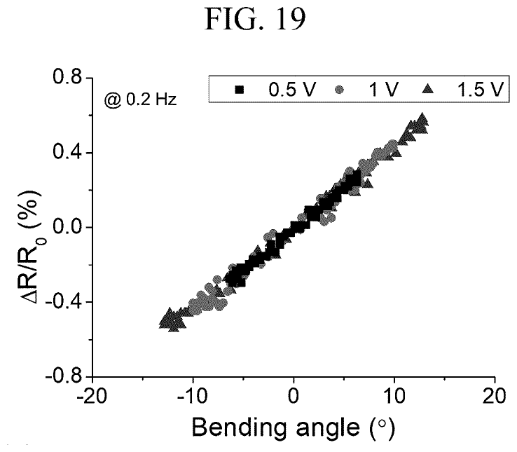

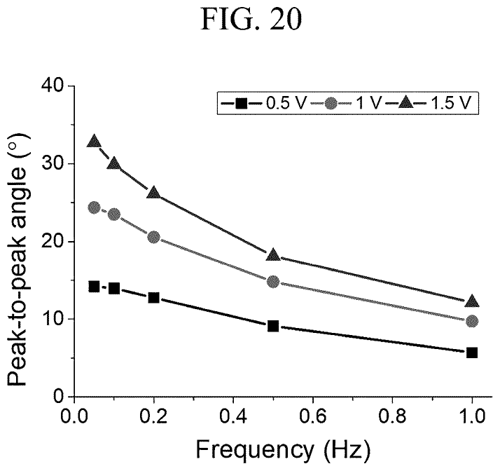

The bending angle and the sensitivity of the optimally designed iEAP actuator were experimentally characterized. FIG. 18 shows the experimental results of the bending angle and the sensitivity of the sensor-integrated iEAP actuators under sine voltages of 0.5 V, 1 V, and 1.5 V at 0.2 Hz, demonstrating an excellent real-time change in the resistance to deformation (data measured at different frequencies are provided in FIG. 12A to FIG. 12D). The blocking forces of the iEAP actuators measured at 2 V and 0.2 Hz without and with encapsulation are provided in FIG. 13. FIG. 19 further confirms the consistency of the sensitivity under different driving voltages at 0.2 Hz by showing an excellent linear correlation between θ and ΔR/R₀ without hysteresis. Although increasing the frequency of the sine voltages resulted in a reduction in the peak-to-peak angle (FIG. 20), the relation in which the angle increases with Vᵢₙ was maintained. A high peak-to-peak angle of 12° was achieved at 1 Hz and 1.5 V, which is unprecedented for sensor-integrated actuators driven by an iEAP actuator, which constitutes only 6% of the total thickness.

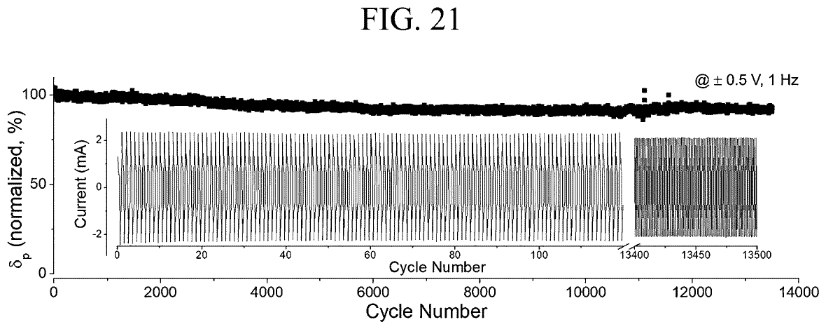

Owing to the excellent flexibility, high electrical conductivity, and high compatibility of EGaIn with silicone elastomers, durable sensor signals with high sensitivity were obtained. This enabled a durable actuation performance for the sensor-integrated iEAP actuator with a stable current flow over 12,000 cycles without significant decreases in the bending performance. FIG. 21 shows the representative data obtained at ±0.5 V and 1 Hz, demonstrating the potential applications of the sensor-integrated iEAP actuator according to an embodiment to various programmable soft robots with long-term use. The slight drift of the actuation and the sensor signal is due to the Mullins effect (L. Mullins, Rubber Chem. Technol. 1969, 42, 3390), which could be easily handled by a simple recalibration since the sensor signal is highly linear to the bending angle (Refer to FIG. 19).

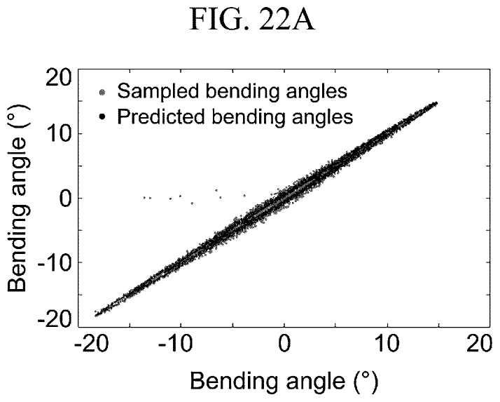

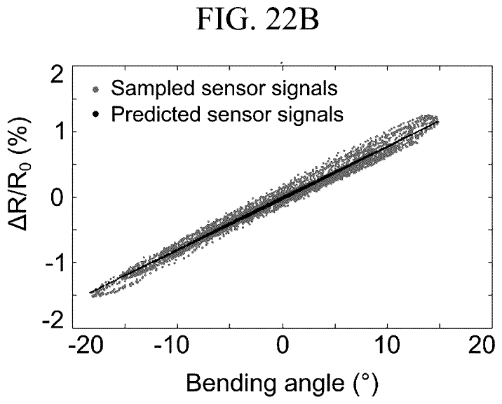

The accurate measurement of the actuator motion in real time by the introduction of a liquid-metal sensor layer enabled active control of the sensor-integrated iEAP actuator by modeling the dynamic deformation and corresponding sensor signal. For this purpose, the 6 and ΔR/R₀ values were sampled under various sinusoidal voltage inputs with different amplitudes and frequencies, which were used to fit the discrete-time linear system model. The results are shown in FIG. 22A and FIG. 22B:

$$\begin{matrix}{θ}_{k + 1} = {A}_{d} {θ}_{k} + {B}_{d} {V}_{i n , k} \\ {( \frac{Δ R}{{R}_{0}} )}_{k} = {C}_{d} {θ}_{k}\end{matrix} . \qquad ( 6 )$$

### (2) Tracking Control and Teleoperation

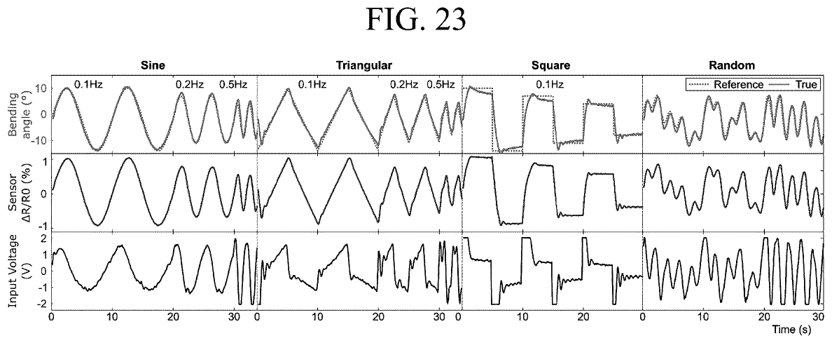

The sensor-integrated iEAP actuator was successfully controlled based on the identified system model to track a predetermined trajectory. FIG. 23 shows representative results, where the actuators accurately track the predefined target trajectories (dotted Reference) with various shapes (sine, triangle, square, and random) and frequencies of 0.1, 0.2, and 0.5 Hz. During tracking control, the input voltage was calculated using the model predictive control (MPC) method, which determines the optimal control in a receding time horizon(E. F. Camacho, C. B. Alba, Model predictive control, Springer science & business media, 2013).

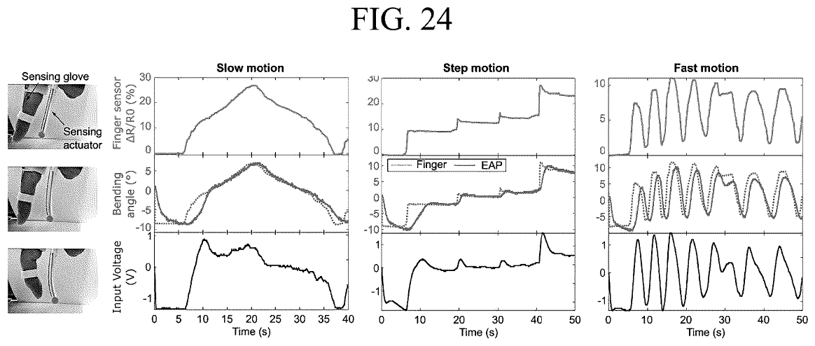

As shown in FIG. 24, the sensor-integrated iEAP actuator is controlled to follow the joint motion of a human finger, measured independently using a wearable sensing glove. The measured signal was transformed to the target bending angle of the iEAP actuator (dotted curves) using pre-determined mapping in real time. The calculated bending angles were entered into the controller as a receding reference for each time step. As shown in FIG. 24, the sensing actuator follows the slow (0.03 Hz), step (0.1 Hz), and fast (0.2 Hz) motions of the finger. The delay between the target trajectory generated from the finger and the controlled motion trajectory of the actuator is attributed to the size of the time window of the reference bending angles, which can be resolved by reducing the window size. However, this will increase the tracking error because the identified dynamics in Equation (6) cannot be fully utilized.

The proposed interactive teleoperation of the sensor-integrated iEAP actuator requires a closed loop between the user and the sensor-integrated actuator. After the actuator moves according to the user's command, its status must be transmitted to the user again to determine the next command. Taking advantage of the precisely controllable bending deformation of the sensor-integrated actuator, similar to the motion of human fingers, we discuss the results obtained when using it in gripper applications. In this case, the most important information is whether the gripper holds the object. Encouragingly, without the need to introduce additional sensors, our sensor-integrated actuator can statistically provide contact information, through the proprioceptive strain signal. We established two different system models based on the motion of the sensor-integrated actuator in two ways: free motion and contact phases. These can be distinguished by the strain sensor signal using the interactive multiple model (IMM) method (Y. Bar-Shalom, K. C. Chang, H. A. Blom, IEEE Trans. Aerosp. Electron. Syst. 1989, 25, 296).

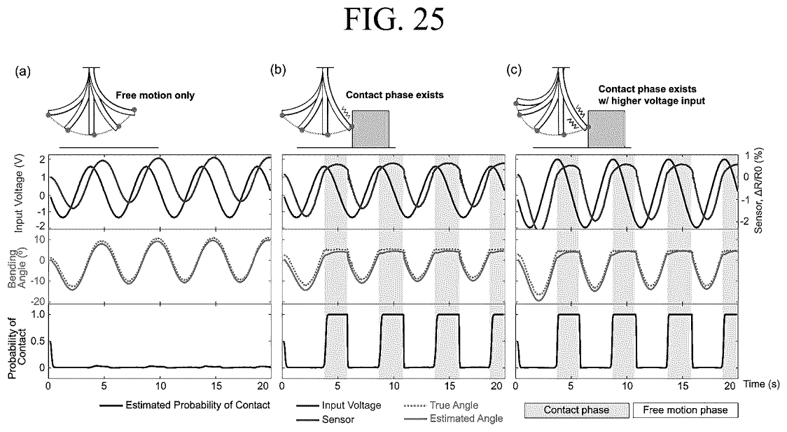

FIG. 25 shows the representative results of the IMM estimation for the three different motions of the sensor-integrated actuator. Unlike the case of free movement without contact with the object ((a) in FIG. 25), a plateau of the bending angle was observed for the actuator during the contact phases even when the changed input voltage was continuously applied ((b) and (c) in FIG. 25). However, the EGaIn sensor signal continued to change owing to the compressive force acting on the contact area of the EGaIn pattern, as well as further deformation of the actuator while its tip was fixed. Using these signals, the IMM estimates the contact phase (as the probability of contact in the bottom plots) to match the true state (shaded in gray when it is in contact).

(3) Interactive Teleoperation of Soft Gripper with Haptic Feedback

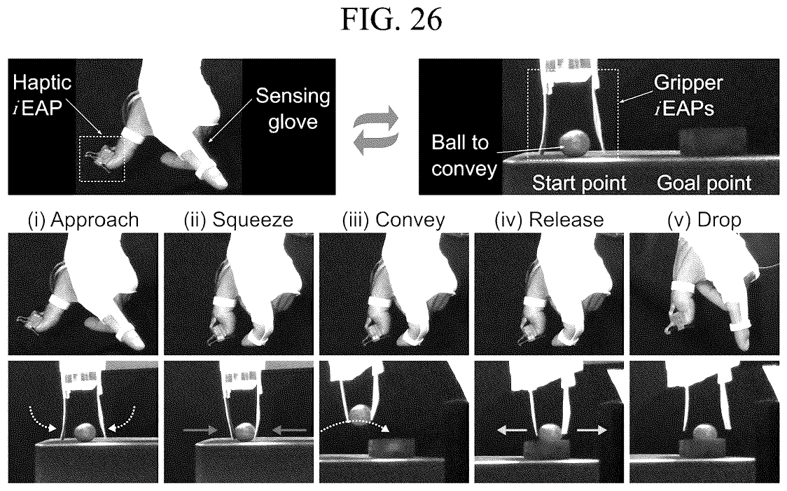

We have developed a haptic interactive system that can teleoperate a soft gripper using a human hand and provide versatile self-sensing functions, as illustrated in FIG. 26.

In particular, the introduction of a wearable fingertip haptic device based on the iEAP actuator that can provide cutaneous feedback with small batteries enables truly portable low-voltage-based haptic systems. Note that the bending angle of the user's hand is greater than that of gripper tip, and linear mapping was used to match the maximum finger angle and maximum gripper angle. The bottom panel of FIG. 26 shows the interactive teleoperation of the gripper by the human hand in performing five tasks. First, the gripper approached the ball by tracking the target angles, which were calculated from the finger motion tracked using the sensing glove. When the gripper started to contact the ball, the user bent the fingers to squeeze the ball for a stable grasping motion. The user then conveyed the ball to the goal point to release and drop it.

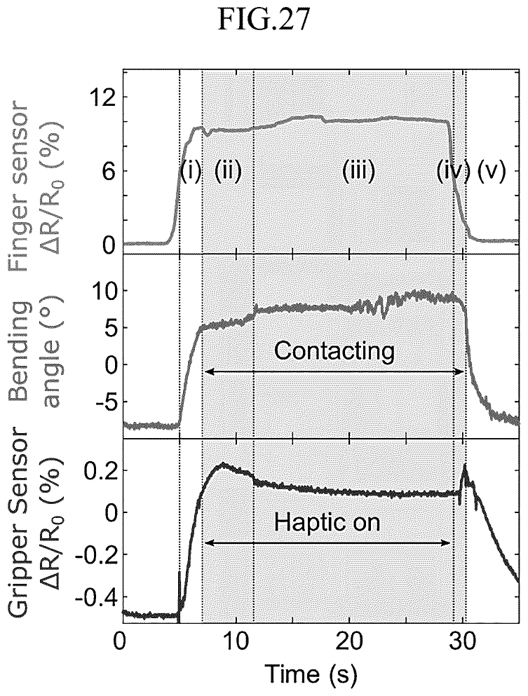

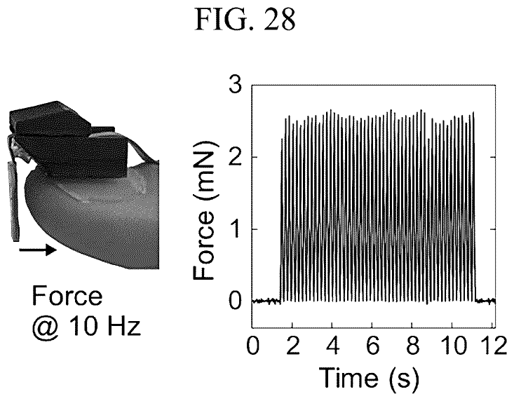

FIG. 27 shows the measured states of the system upon task completion. When the gripper was in contact with the ball, the sensor signal of the gripper changed significantly. Once this difference was detected by the IMM algorithm, the haptic iEAP actuator was activated to provide tactile feedback to the user. Based on this tactile feedback, the user could decide whether to squeeze further or move the ball to the goal point. When the ball was released from the gripper, the gripper signal showed a peak owing to frictional resistance and static attraction. Contact with the ball was communicated to the tip of the thumb as a tactile feedback signal by the haptic iEAP actuator, as shown in the image in FIG. 28. When the module is turned on, the iEAP actuator vibrates at 10 Hz to provide unprecedented stimuli to the fingertip. The normal force measured by the haptic iEAP actuator at 2 V and 10 Hz is shown on the right plot in FIG. 28.

An iEAP haptic device operating at a high frequency is unprecedented before the priority date of the present application. The iEAP actuator according to an embodiments exhibits high operational strain at very high frequencies at very low drive voltages. There is also no known encapsulated iEAP actuator that exhibits equivalent or higher actuation force than non-encapsulated iEAP actuator. The elastomer-encapsulated iEAP actuator according to an embodiment moves rapidly and generates high actuation stress at a low driving voltage, which enabled the proposed haptic interactive system. The creation of a Morse code-like signal with combinations of various haptic feedbacks operating at different frequencies can be further envisioned. Development of advanced haptic feedback devices that can generate controlled contact strengths by increasing the force level of the iEAP actuator remains a future work.

Notably, in the absence of haptic feedback, users have to rely on visual information, making it difficult to confirm the stable grasping motion. For example, when gripping through point contact or when trying to grasp a fragile object, it is important to apply an appropriate level of grip force. From this standpoint, our approach establishes a platform for practically viable haptic devices that do not require additional sensors for versatile and scalable haptic systems with small batteries.

Although the embodiments have been described in detail above, the scope of rights is not limited thereto, and various modifications and improvements made by those skilled in the art using the basic concepts defined in the claims also fall within the scope of rights.

What is claimed is:

1. A haptic interaction system comprising:
a sensing glove configured to be worn on a user's hand to detect movement of the user's hand;
a soft gripper comprising a sensor-integrated actuator and configured to be operated according to the movement of the user's hand;
a haptic device comprising an ionic electroactive polymer actuator and providing haptic feedback of the soft gripper to the user's hand; and
a haptic interface that generates tracking control that synchronizes movement of the user's hand with the movement of the soft gripper and generates a haptic feedback signal from a physical contact of the soft gripper with an object.

2. The haptic interaction system according to claim 1, wherein the sensor-integrated actuator comprises an ionic electroactive polymer actuator, and a strain sensor coupled to the ionic electroactive polymer actuator of the sensor-integrated actuator.

3. The haptic interaction system according to claim 2, wherein at least one of the ionic electroactive polymer actuator and the strain sensor of the sensor-integrated actuator is encapsulated with an elastomer.

4. The haptic interaction system according to claim 2, wherein the strain sensor comprises an eutectic gallium-indium alloy.

5. The haptic interaction system according to claim 1, wherein the sensor-integrated actuator comprises a strain sensor printed on an elastomer film, and an ionic electroactive polymer actuator laminated on the strain sensor, wherein the ionic electroactive polymer actuator of the sensor-integrated actuator is sealed with an elastomer.

6. The haptic interaction system according to claim 1, wherein the ionic electroactive polymer actuator comprises a pair of flexible electrodes that face each other, and a polymer electrolyte membrane interposed between the pair of flexible electrodes, wherein the polymer electrolyte membrane comprises a polymer that comprises a structural unit represented by Chemical Formula 1, and an ionic liquid: 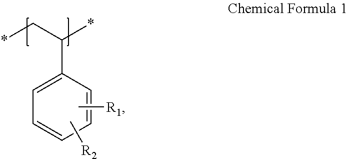
wherein in Chemical Formula 1,
R₁ and R₂ are, each independently, —OH, —COOH, —SO₃H, —PO₃H₂, —NH₂, imidazolyl group, —SO₂N(X₁)SO₂CF₃, or —CN, wherein X₁ is hydrogen, or a substituted or unsubstituted C₁ to C₃₀ alkyl group, and
wherein R₁ and R₂ are located adjacent to each other.

7. The haptic interaction system according to claim 6, wherein Chemical Formula 1 is represented by Chemical Formula 1-1 or Chemical Formula 1-2: 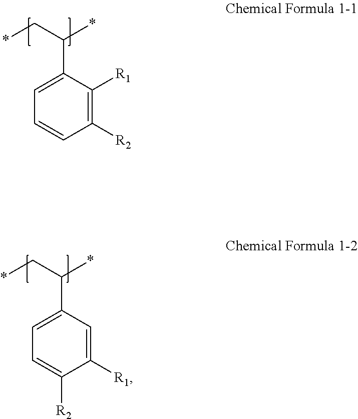
wherein in Chemical Formula 1-1 and Chemical Formula 1-2,
R₁ and R₂ are, each independently, the same as defined in Chemical Formula 1.

8. The haptic interaction system according to claim 6, wherein Chemical Formula 1 is represented by Chemical Formula 2:

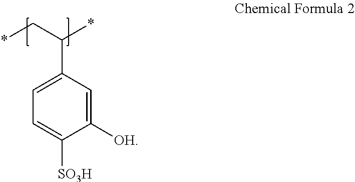

9. The haptic interaction system according to claim 6, wherein the ionic liquid comprises a cationic liquid, an anionic liquid, a neutral liquid, or a combination thereof.

10. The haptic interaction system according to claim 9, wherein
the cationic liquid comprises imidazolium, pyrrolidinium, piperidinium, alkylmethylimidazolium, or a combination thereof;
the anionic liquid comprises trifluoroacetate, trifluoromethanesulfonate, bis(fluorosulfonyl)imide, bis(trifluoromethanesulfonyl)imide, Dicyanamide, tetracyanoborate, dihydrogenphosphate), hydrogen sulfate, or a combination thereof; and
the neutral liquid comprises 1-ethyl-3-methylimidazolium-bis(trifluoromethylsulfonyl)imide, 1-methyl-3-propylimidazolium iodide, 1-ethyl-3-methylimidazolium tetrafluoroborate, 1-ethyl-3-methylimidazolium trifluoromethanesulfonate, 1-ethyl-3-methylimidazolium hydrogensulfate, N-methyl-N-butylpyrrolidinium-bis(trifluoromethanesulfonyl) imide, or a combination thereof.

11. The haptic interaction system according to claim 9, wherein the ionic liquid comprises a mixture of the cationic liquid and the anionic liquid at a molar ratio of 1:10 to 10:1.

12. The haptic interaction system according to claim 6, wherein at least one of the pair of flexible electrodes comprises a single-walled carbon nanotube electrode, a multi-walled carbon nanotube electrode, a poly(3,4-ethylenedioxythiophene): polystyrene sulfonate conductive polymer electrode, gold electrode, a platinum electrode, or a combination thereof.

13. The haptic interaction system according to claim 1, wherein the sensing glove comprises a strain sensor that detects movement of joint of a user's finger.

14. The haptic interaction system according to claim 13, wherein the strain sensor included in the sensing glove comprises an eutectic gallium-indium alloy.

15. The haptic interaction system according to claim 1, wherein the haptic device is mounted on a user's fingertip.

16. A sensor-integrated actuator comprising:
a strain sensor;
an elastomer film on the strain sensor; and
an ionic electroactive polymer actuator on the elastomer film,
wherein the ionic electroactive polymer actuator comprises a pair of flexible electrodes that face each other, and a polymer electrolyte membrane interposed therebetween, and
wherein the polymer electrolyte membrane includes a polymer that comprises a structural unite represented by Chemical Formula 1, and an ionic liquid: 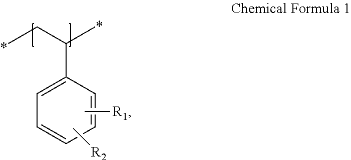
wherein in Chemical Formula 1,
R₁ and R₂ are, each independently, —OH, —COOH, —SO₃H, —PO₃H₂, —NH₂, imidazolyl group, —SO₂N(X₁)SO₂CF₃, or —CN, wherein X₁ is hydrogen, or a substituted or unsubstituted C₁ to C₃₀ alkyl group, and
wherein R₁ and R₂ are located adjacent to each other.

17. The sensor-integrated actuator according to claim 16, wherein Chemical Formula 1 is represented by Chemical Formula 1-1 or Chemical Formula 1-2: 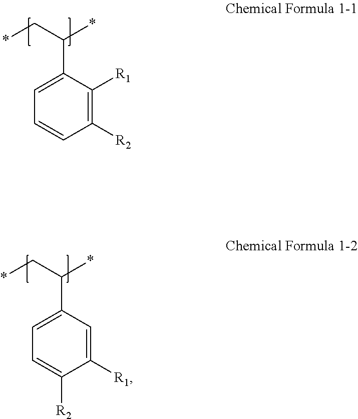
wherein in Chemical Formula 1-1 and Chemical Formula 1-2,
R₁ and R₂ are, each independently, the same as defined in Chemical Formula 1.

18. The sensor-integrated actuator according to claim 16, wherein the strain sensor comprises an eutectic gallium-indium alloy.

19. The sensor-integrated actuator according to claim 16, wherein Chemical Formula 1 is represented by Chemical Formula 2, and the ionic liquid comprises a mixture of a cationic liquid and an anionic liquid at a molar ratio of 1:10 to 10:1:

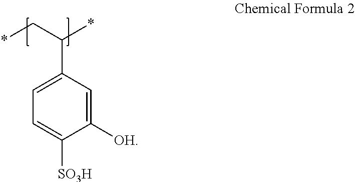

20. The sensor-integrated actuator according to claim 16, wherein the ionic liquid comprises 1-ethyl-3-methylimidazolium, bis(trifluoromethylsulfonyl)imide, or a combination thereof.
